(19) United States
(12) Patent Application Publication
(10) Pub. No.: US 2024/0171332 A1
(43) Pub. Date: May 23, 2024

(54) METHODS AND APPARATUSES FOR REFERENCE SIGNAL TRANSMISSION

(71) Applicant: InterDigital Patent Holdings, Inc., Wilmington, DE (US)

(72) Inventors: Young Woo Kwak, Woodbury, NY (US); Moon IL Lee, Melville, NY (US); Paul Marinier, Brossard (CA); Nazli Khan Beigi, Longueuil (CA); Prasanna Herath, Laval (CA)

(21) Appl. No.: 18/284,911

(22) PCT Filed: Mar. 29, 2022
(86) PCT No.: PCT/US2022/022310

§ 371 Date: Sep. 29, 2023

Related U.S. Application Data
(60) Provisional application No. 63/168,111, filed on Mar. 30, 2021.
(60) Provisional application No. 63/249,271, filed on Sep. 28, 2021.

(51) Int. Cl. H04L 5/00; H04B 7/06

(52) U.S. Cl. CPC H04L 5/0048; H04B 7/0626; H04B 7/06968

(57) ABSTRACT

Methods, apparatuses, systems, and/or procedures for reference signal (RS) transmissions and receptions in wireless communications (e.g., 5G NR) are disclosed. For example, a method implemented by a wireless transmit/receive unit (WTRU) includes receiving configuration information indicating a set of RS resources, a set of candidate RS resources, and a threshold; receiving a first RS in an RS resource of the set of RS resources; selecting a candidate RS resource from the set of candidate RS resources, based on a determination that a measurement result of the received first RS is less than or equal to the threshold; and receiving a second RS in the selected candidate RS resource.

### CROSS-REFERENCE TO RELATED APPLICATION(S)

This application claims priority to and the benefit of U.S. Provisional Application No. 63/168,111 filed in the U.S. Patent and Trademark Office on Mar. 30, 2021, and U.S. Provisional Application No. 63/249,271 filed in the U.S. Patent and Trademark Office on Sep. 28, 2021, the entire contents of each of which being incorporated herein by reference as if fully set forth below in their entirety and for all applicable purposes.

### SUMMARY

The present disclosure is generally directed to the fields of communications networks, wireless and/or wired. For example, one or more embodiments disclosed herein are related to methods, apparatuses, systems, and/or procedures for reference signal (RS) transmissions and receptions in wireless communications (e.g., 5G NR).

In one embodiment, a method implemented by a wireless transmit/receive unit (WTRU) for wireless communications includes receiving configuration information indicating a set of RS resources, a set of candidate RS resources, and a threshold; receiving a first RS in an RS resource of the set of RS resources; selecting a candidate RS resource from the set of candidate RS resources, based on a determination that a measurement result of the received first RS is less than or equal to the threshold; and receiving a second RS in the selected candidate RS resource.

In another embodiment, a method implemented by a WTRU for wireless communications includes receiving configuration information indicating a set of RS resources and a set of candidate RS resources; determining a Listen-Before-Talk (LBT) failure for one or more RSs associated with the set of RS resources; determining, based on the configuration information and the determined LBT failure, one or more candidate RS resources from the set of candidate RS resources; and receiving an RS transmission using the determined one or more candidate RS resources.

In one embodiment, the WTRU comprising a processor, a transmitter, a receiver, and/or memory is configured to implement one or more methods disclosed herein. For example, the WTRU is configured to receive configuration information indicating a set of RS resources, a set of candidate RS resources, and a threshold; to receive a first RS in an RS resource of the set of RS resources; to select (or determine) a candidate RS resource from the set of candidate RS resources, based on a determination that a measurement result of the received first RS is less than or equal to the threshold; and to receive a second RS in the selected candidate RS resource.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref.”) in the Figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a table illustrating frequencies between 52.6 GHz and 71 GHz used in different countries, according to one or more embodiments;

FIG. 3 is a table illustrating frequencies between 71 GHz and 100 GHz used in different countries, according to one or more embodiments;

FIG. 4 is a diagram illustrating an exemplary operation of reference signal (RS) transmission, according to one or more embodiments;

FIG. 5 is a diagram illustrating an exemplary operation of RS transmission in one or more RS candidates when a Listen-Before-Talk (LBT) failure for one or more RSs, according to one or more embodiments;

FIG. 6 are slot diagrams each illustrating an example of quasi-colocation (QCL) assumption determination for multiple physical downlink shared channels (PDSCHs), according to one or more embodiments;

FIG. 7 is a diagram illustrating an example of dynamic RS resource(s) determination based on measured quality, transmission type(s), and/or number(s) of antenna ports, according to one or more embodiments; and

FIG. 8 is a flow chart illustrating an exemplary operation of dynamic RS resource(s) determination and RS transmission(s)/reception(s), according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System and Devices

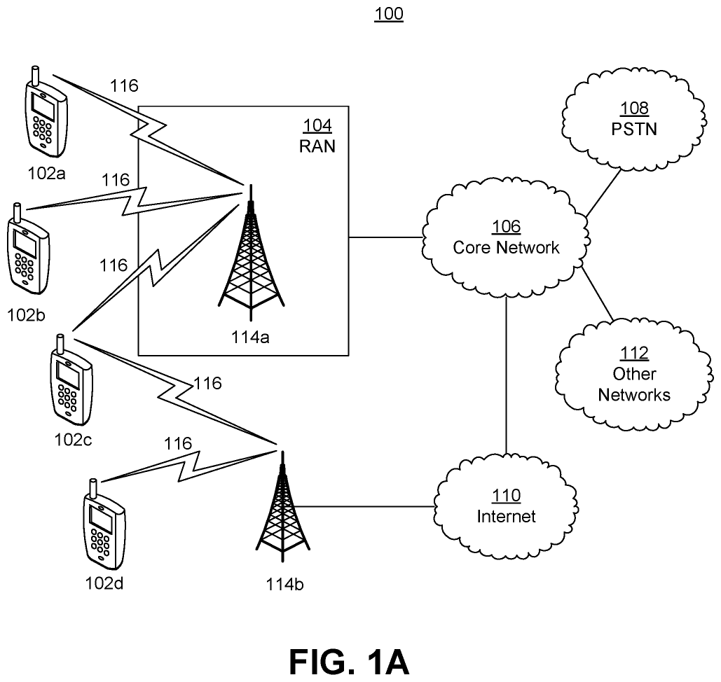

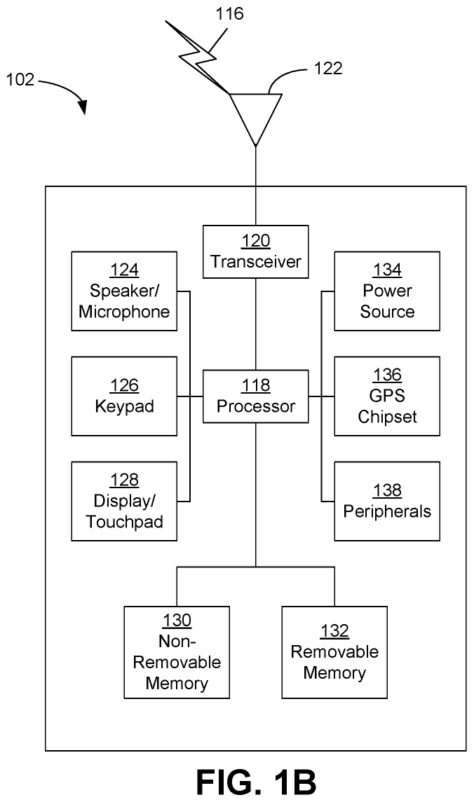

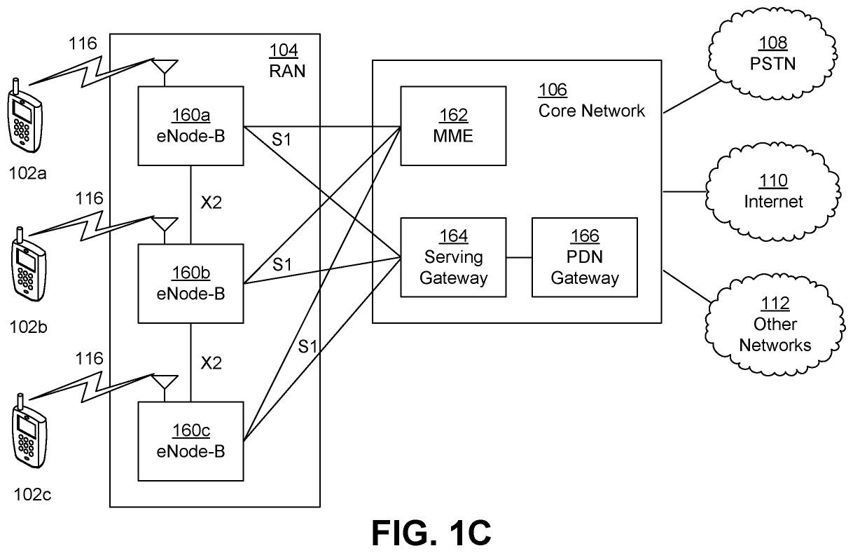

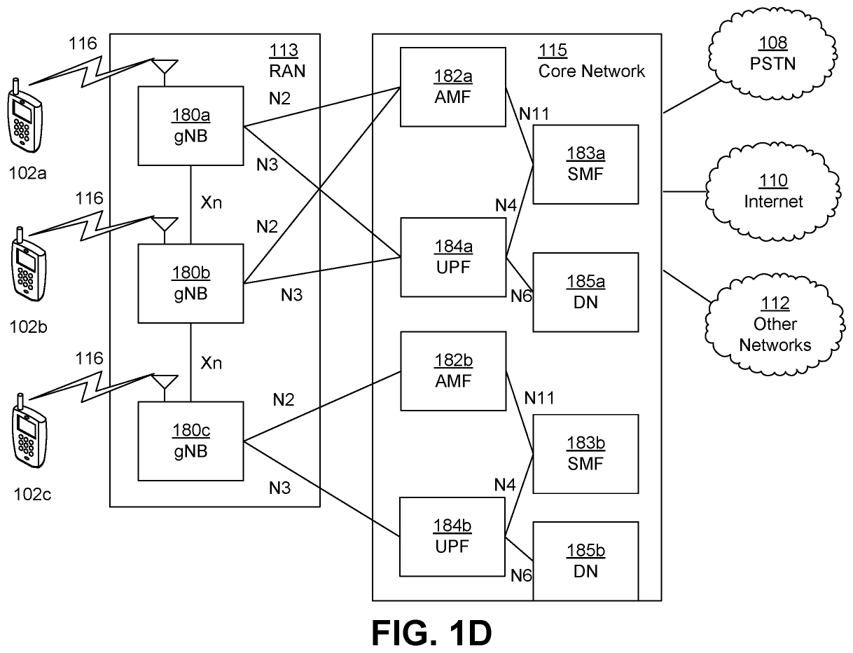

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram of an example communications system 100 in which one or more disclosed embodiments may be implemented. Example communications system 100 is provided for the purpose of illustration only and is not limiting of the disclosed embodiments. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronic device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. Example WTRU 102 is provided for the purpose of illustration only and is not limiting of the disclosed embodiments. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. For example, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules/units that provide additional features, functionality and/or wired or wireless connectivity. For example, the peripherals 138 may include an accelerometer, an e-compass, a satellite transceiver, a digital camera (e.g., for photographs or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram of the RAN 104 and the CN 106 according to another embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The core network 106 shown in FIG. 1C may include a mobility management gateway (MME) 162, a serving gateway (SGW) 164, and a packet data network (PDN) gateway 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may also perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different packet data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein generally relate to communication networks, wireless and/or wired. For example, one or more embodiments disclosed herein are related to methods, apparatuses, systems, and/or procedures for reference signal (RS) transmission (e.g., using shared spectrum, and/or unlicensed bands in high frequencies) in wireless communications.

### Introduction

In 5G New Radio (NR), reference signal (RS) transmissions and/or measurements by a network entity (e.g., a gNB) and one or more WTRUs are crucial for wireless communications and operations. In an example, a Channel State Information-Reference Signal (CSI-RS) for tracking (e.g., Tracking Reference Signal or TRS) may be transmitted by the network entity, and a WTRU may achieve fine time/frequency tracking based on the transmitted (or received) TRS. In another example, the WTRU may measure one or more transmitted RSs and determine one or more CSI parameters (e.g., one or more CSI-RS Resource Indicators (CRIs), Rank Indicators (RIs), Layer Indicators (LIs), Precoding Matrix Indicators (PMIs), and/or wideband/subband Channel Quality Indicators (CQIs)). The WTRU may report the determined one or more CSI parameters to the network entity. However, shared spectrum operation in unlicensed bands may require Listen-Before-Talk (LBT) for RS transmissions as well as for other channels and signals. For example, a network entity may, before RS transmissions, assess (or determine) whether a channel being clear or not. If the channel is clear, the network entity may transmit one or more RSs to a WTRU. If the channel is not clear, the network entity may not transmit the one or more RSs to the WTRU. If the RSs are not transmitted, incorrect operation(s) based on measurements of RSs that are not transmitted may occur. For example, if the WTRU determines channel qualities for one or more of: beam management, CSI reporting, beam failure recovery, and/or RRM/RLM based on RSs that are not transmitted, a RS with a high channel quality may be determined as a low channel quality due to absence of transmitted or received signal. In another example, if the WTRU tracks time/frequency synchronization based on RSs that are not transmitted, the WTRU may lose time/frequency tracking for the network entity and may need handover to other network entities (e.g., one or more other gNBs).

### NR Beyond 52.6 GHz

In New Radio (NR) beyond 52.6 GHz, according to a survey of a study item, there are minimum 5 GHz of spectrum available globally (between 57 GHz and 64 GHz) for unlicensed operation, and in some countries up to 14 GHz of spectrum (between 57 GHz and 71 GHz) for unlicensed operation. Additionally, the survey has identified minimum of 10 GHz of spectrum available globally (between 71 GHz to 76 GHz and 81 GHz to 86 GHz) for licensed operation, and in some countries up to 18 GHz of spectrum available (between 71 GHz and 114.25 GHz) for licensed operation. While frequency ranges above 52.6 GHz potentially contain larger spectrum allocations and larger bandwidths that are not available for bands lower than 52.6 GHz, however, physical layer channels of NR were designed to be optimized for uses under 52.6 GHz.

### Operation(s) in a Shared Spectrum

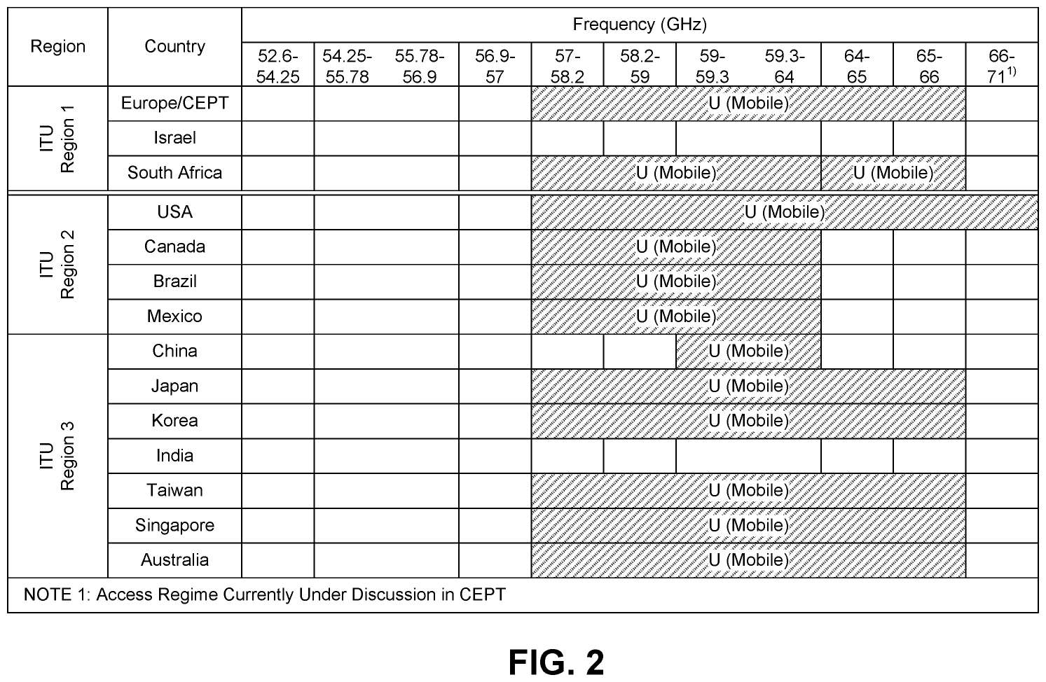

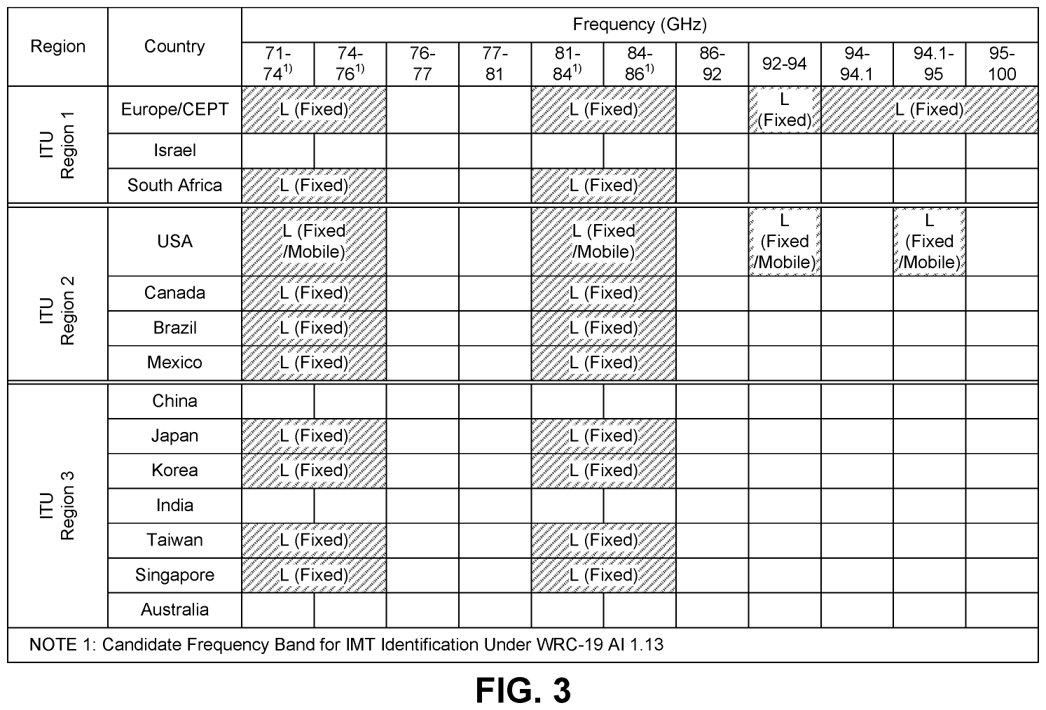

Referring to FIG. 2 and FIG. 3, most of available frequencies between 52.6 GHz and 71 GHz are unlicensed spectrums which require shared spectrum operation. Channel access in an unlicensed frequency band typically uses a Listen-Before-Talk (LBT) mechanism. LBT is typically mandated independently of whether the channel is occupied or not.

For frame-based systems, LBT may be characterized by a Clear Channel Assessment (CCA) time (e.g., ˜20 μs), a Channel Occupancy time (e.g., minimum 1 ms, maximum 10 ms), an idle period (e.g., minimum 5% of channel occupancy time), a fixed frame period (e.g., equal to the channel occupancy time plus the idle period), a short control signaling transmission time (e.g., maximum duty cycle of 5% within an observation period of 50 ms), and a CAA energy detection threshold.

For load-based systems (e.g., transmit/receive structure may not be fixed in time), LBT may be characterized by a number N corresponding to the number of clear idle slots in extended CCA instead of the fixed frame period. N may be selected randomly within a range.

Deployment scenarios may include different standalone NR-based operation(s), different variants of dual connectivity operation(s) (e.g., 1) EN-DC with at least one carrier operating according to LTE radio access technology (RAT), or 2) NR DC with at least two sets of one or more carriers operating according to the NR RAT), and/or different variants of carrier aggregation (CA) (e.g., possibly also including different combinations of zero or more carriers, and each carrier may use LTE RAT or NR RAT).

For example, for LTE, listen-before-talk (for clear channel assessment) is considered for an LAA system. The listen-before-talk (LBT) procedure is defined as a mechanism by which an equipment applies a clear channel assessment (CCA) check before using the channel. The CCA utilizes at least energy detection to determine the presence or absence of other signals on a channel in order to determine whether a channel is occupied or clear, respectively. European and Japanese regulations mandate the usage of LBT in unlicensed bands. Apart from regulatory requirements, carrier sensing via LBT is one way for fair sharing of unlicensed spectrum, and it is considered to be a vital feature for fair and friendly operation in unlicensed spectrum (e.g., in a single global solution framework).

### Overview

In NR, reference signal (RS) transmissions and/or measurements performed by a network entity (e.g., a gNB) and/or one or more WTRUs are crucial for any of the following operations:
Time/frequency tracking. For example, CSI-RS for tracking (TRS) may be transmitted by a network entity, and a WTRU may achieve fine time/frequency tracking based on the received TRS from the network entity.
Beam management. For example, the WTRU may measure one or more transmitted RSs and determine one or more optimized beams based on L1-RSRP and/or L1-SINR. The WTRU may report the determined one or more optimized beams based on CSI reporting with one or more of CRIs, L1-RSRPs, and/or L1-SINRs.
CSI reporting. For example, the WTRU may measure one or more transmitted RSs and determine one or more CSI parameters (e.g., one or more of CRIs, RIs, LIs, PMIs, and wideband/subband CQIs). The WTRU may report the determined one or more CSI parameters to the network entity.
Beam failure recovery (BFR). For example, the WTRU may monitor quality of a PDCCH reception based on measurements of one or more transmitted RSs. If measured quality (e.g., hypothetical PDCCH block error rate (BLER)) of the one or more transmitted RSs is below a threshold, the WTRU may report a beam failure to the network entity with a candidate/new beam determined based on the measured quality (e.g., L1-RSRP).
Radio Resource Management (RRM) and/or Radio Link Monitoring (RLM). For example, the WTRU may measure one or more RSs (e.g., SSBs) and assess channel qualities of multiple cells. Based on the channel qualities, the WTRU may handover from a current cell to a new cell.

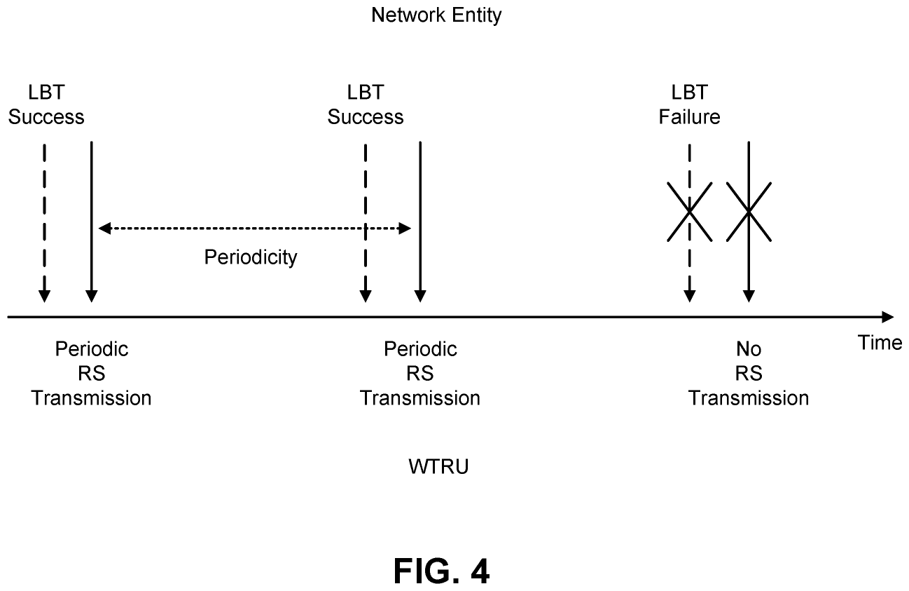

However, shared spectrum operation in unlicensed bands may require LBT for RS transmissions as well as for other channels and signals. For example, referring to FIG. 4, LBT is performed before RS transmissions in shared spectrum. In this example, a gNB may, before RS transmissions, assess/determine whether a channel is clear or not. If the channel is clear, the gNB may transmit one or more RSs to a WTRU. If the channel is not clear, the gNB may not transmit the one or more RSs to the WTRU. For example, if a RS resource with a configured periodicity (e.g., configured periodic RS resource and/or activated semi-persistent RS resource) is not transmitted when the channel is not clear, the WTRU may need to wait for the configured periodicity until the next RS transmission instance. In some cases, the delayed measurement may degrade system performance due to delayed update of channel related information (e.g., one or more of CSI, RRM, RLM, and/or BFR).

In an example, PDSCH/PUSCH performance may be degraded due to inaccurate MCSs for PDSCH/PUSCH transmission because of the delayed measurement. In another example, BFR may not be triggered due to the delayed measurement (e.g., based on a delayed detection of beam failure instance).

In an example, if a RS resource is dynamically triggered (e.g., aperiodic RS resource/resource set trigger via DCI) and the RS resource is not successfully transmitted when the channel is not clear, increased DCI overhead may occur as the WTRU may need to receive another DCI trigger (e.g., to receive the RS resource) when the channel is clear.

In addition, if the RSs are not transmitted, system performance may be degraded due to incorrect information based on measurements of the RSs that are not transmitted. For example, if the WTRU determines channel qualities for one or more of beam management, CSI reporting, beam failure recovery, and/or RRM/RLM based on RSs that are not transmitted, a channel/link with a high channel quality may be determined as a low channel quality due to the absence of transmitted signal. In another example, if the WTRU tracks time/frequency synchronization based on RSs that are not transmitted, the WTRU may lose time/frequency tracking for the gNB and may need handover to other gNBs.

Representative Procedures for Reference Signal (RS) Configurations and Transmissions

Various embodiments disclosed herein are related to methods, apparatuses, and/or procedures for reference signal (RS) configurations and transmissions (e.g., using shared spectrum) in wireless communications networks. In one embodiment, candidate RSs configuration/activation may be used or enabled, and a WTRU may receive one or more RSs based on the candidate RSs configuration/activation if an LBT for RS transmissions fails. In one embodiment, LBT types may be configured or determined based on priorities. For example, a procedure may increase RS transmission probability by changing LBT types and/or priorities for RSs (e.g., one or more failed RS transmissions). In one embodiment, by determining RS transmission failure by a gNB and/or a WTRU, accurate operations may be enabled. In one embodiment, rate matching of one or more RSs may be performed/used for channels (or signals) that are transmitted in candidate RS slots/opportunities/resources due to LBT failure. In one embodiment, an RS transmission scheme may be enabled by changing a beam for a respective RS transmission. In one embodiment, receiver-aided LBT operation(s) for RS transmission may be enabled/used and may resolve hidden node problems for RS transmissions.

### Definition of Beam

In various embodiments, a WTRU may transmit or receive a physical channel (or a reference signal) according to at least one spatial domain filter. The term “beam” may be used to refer to a spatial domain filter.

The WTRU may transmit a physical channel or signal using the same spatial domain filter that is used for receiving an RS (e.g., CSI-RS) or a SS block. The WTRU transmission may be referred to as a “target”, and the received RS or SS block may be referred to as a “reference” or “source”. In such case, the WTRU may be considered as to transmit the target physical channel or signal according to a spatial relation with a reference to such RS or SS block.

The WTRU may transmit a first physical channel or signal according to the same spatial domain filter that is used for transmitting a second physical channel or signal. The first transmission and the second transmission may be referred to as a “target” and a “reference” (or “source”), respectively. In such case, the WTRU may be considered as to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) (e.g., indicated in DCI, or configured by RRC). In another example, a spatial relation may be configured by RRC for an SRI or signaled by MAC CE for a PUCCH. Such spatial relation may also be referred to as a “beam indication.”

The WTRU may receive a first (target) downlink channel or signal according to the same spatial domain filter or spatial reception parameter as a second (reference) downlink channel or signal. For example, such association may exist between a physical channel such as PDCCH or PDSCH, and/or its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated/signaled an association between a CSI-RS (or SS block) and a DM-RS by an index to a set of TCI states (configured by RRC and/or signaled by MAC CE). Such indication may also be referred to as a “beam indication”.

Configuration and/or Activation/Deactivation of RS Candidates

In various embodiments, RS resources may be interchangeably used with RSs, RS resource sets, and/or RS configurations. In various embodiments, receiving RS may be interchangeably used with transmitting RS and/or measuring RS and/or determining RS quality. In various embodiments, RS presence may be interchangeably used with successfully transmitted/received RS. In various embodiments, RS absence or not presence may be interchangeably used with not successfully transmitted/received RS and prevented RS, but consistent with this invention.

Usage of One or More Candidate RS Resources

In one embodiment, a WTRU may be configured with one or more RS resources and one or more candidate RS resources (e.g., via RRC message(s)). Based on an LBT operation, whether to use the one or more RS resources or the one or more candidate RS resources for RS transmission may be determined. In an example, the WTRU may use LBT before its RS transmission and/or identify/determine RS presence (e.g., based on a gNB indication and/or WTRU blind detection). Based on the LBT and/or the identification, the WTRU may determine whether a channel for RS transmission being occupied or not. For example, if the channel is determined as not being occupied, the WTRU may determine to receive the one or more RS resources for RS measurement. If the channel is determined as being occupied, instead of receiving RSs in the one or more RS resources, the WTRU may determine to receive the one or more candidate RS resources for RS measurement.

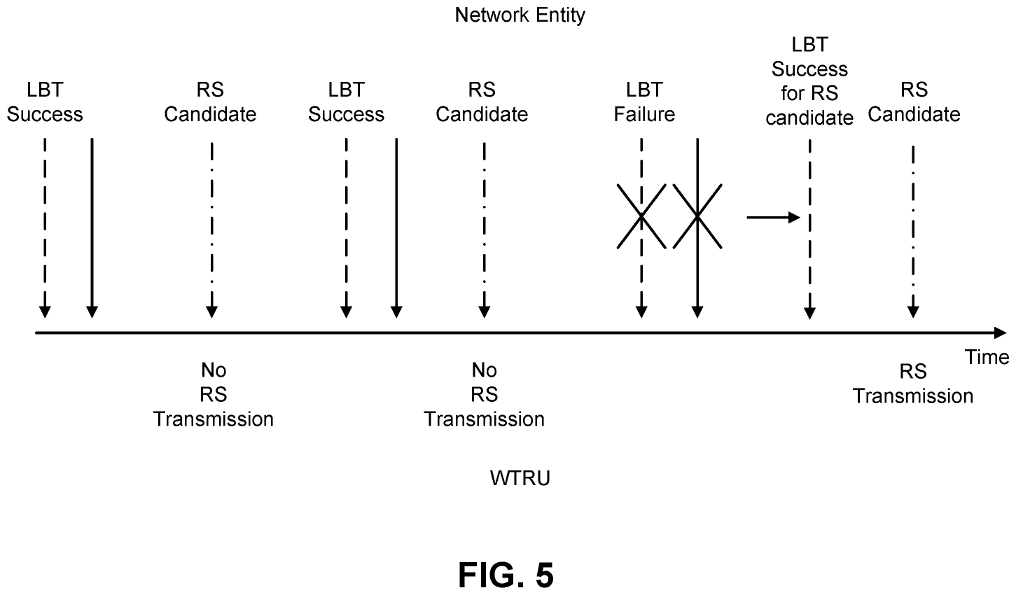

In an example, referring to FIG. 5, a WTRU may receive (or monitor, or detect) RS transmission in one or more candidate RS resources when an LBT failure for one or more RSs occur.

Before receiving one or more candidate RS resources for RS measurement, the WTRU may use LBT and/or identify/determine RS presence for the one or more candidate RS resources. Based on the LBT and/or the identification, the WTRU may determine whether a channel for RS transmission is occupied or not. For example, if the channel is not occupied, the WTRU may determine to receive the one or more candidate RS resources for RS measurement. If the channel is occupied, the WTRU may wait a (e.g., pre-configured) time duration. After waiting (e.g., the time duration), the WTRU may use LBT and/or identify RS presence for the one or more candidate RS resources. If one or more conditions are satisfied, the WTRU may determine not to receive the one or more candidate RS resources. The determination may be based on the one or more conditions being satisfied (e.g., the number of LBT failures and/or the number of RS presence identification failures is larger than a threshold). The determination may be based on the number of LBT failures and/or the number of RS presence identification failures. For example, if the number of LBT failures (and/or the number of RS presence identification failures) is smaller than (or equal to) a threshold (e.g., a pre-configured threshold), the WTRU may determine to use LBT and/or RS identification again. If the number of LBT failures (and/or the number of RS presence identification failures) is larger than the threshold, the WTRU may determine/perform one or more of following:
The WTRU may not use LBT for the one or more candidate RS resources;
The WTRU may not use the identification of RS presence for the one or more candidate RS resources;
The WTRU may not receive the one or more candidate RS resources; and/or
The WTRU may report the LBT failures and/or the identification failures (e.g., to a gNB).

The threshold discussed herein may be based on, for example, one or more of: 1) pre-defined values, 2) semi-statically or dynamically configured/indicated values by a gNB (e.g., by using one or more of RRC, MAC CE, and/or DCI), and/or 3) WTRU reported values (e.g., by reporting WTRU capability).

Configuration/Activation and Indication of Candidate RS Resources

In one embodiment, the WTRU may determine to use one or more of candidate RS resources based on one or more of following: 1) at least one RS resource in a RS resource set fails; 2) if a number of failed RS resources in a RS resource set is larger than a threshold (K), and/or 3) only if all RS resources in a RS resource set fails.

In various embodiments, one or more of following methods/procedures may be used for candidate RS resources with one or more of configurations/activations/indications.

Semi-Static Configuration of Candidate RS Resources

In one embodiment, a WTRU may be configured with one or more candidate RS resources via RRC signaling. The one or more candidate RS resources may be independently configured. In an example, a first configuration of the one or more candidate RS resources may be independent from a second configuration of one or more reference RS resources. For example, the one or more candidate RS resources may be configured with one or more (or a set of) separate information elements (IEs). In this case, association between the one or more RS resources or CSI reporting configurations may be supported based on one or more of following:

Explicit indication. The WTRU may receive ID of associated candidate RS resources among the one or more candidate RS resources semi-statically and/or dynamically (e.g., one or more of RRC, MAC CE and DCI).

Implicit indication. The WTRU may identify associated candidate RS resources based on implicit indication. For example, the WTRU may identify/determine associated candidate RS resources based on one or more of following:
An order of candidate RS resources. In one embodiment, candidate RS resources may be paired with RS resources based on the order of candidate RS resources and RS resources. For example, a first RS resource of the RS resources can be paired with a first candidate RS resource of the candidate RS resources.
A slot/symbol offset of candidate RS resources. In one embodiment, candidate RS resources may be paired with RS resources based on the slot/symbol offset of candidate RS resources and RS resources. For example, a RS resource of the RS resources can be paired with a candidate RS resource of the candidate RS resources if a first offset of the RS resource and a second offset of the candidate RS resource satisfy a given condition (e.g., identical offset, the first offset>the second offset+X (symbol/slots), the first offset<the second offset+X (symbol/slots), the distance between the first offset and the second offset<X (symbols/slots) and etc.)
A frequency location of candidate RS resources. In one embodiment, candidate RS resources may be paired with RS resources based on the frequency location of candidate RS resources and RS resources. For example, a RS resource of the RS resources can be paired with a candidate RS resource of the candidate RS resources if a first frequency resource of the RS resource and a second frequency resource of the candidate RS resource satisfy a given condition (e.g., identical frequency resources, the first frequency resource>the second frequency resource+X (REs/RBs), the first frequency resource<the second frequency resource+X (REs/RBs), the distance between the first frequency resource and the second frequency resource<X (REs/RBs) and etc.).

In one embodiment, the one or more candidate RS resources may be configured within a RS resource. For example, if the one or more candidate RS resources are configured within a first RS resource, the one or more candidate RS resources may be used when LBT for the first RS resource is failed.

Activation/Deactivation of Candidate RS Resources

In one embodiment, a WTRU may receive one or more activation messages from a gNB (e.g., via a MAC CE) based on a set of candidate RS resources that are semi-statically configured. For example, the WTRU may receive one or more activation messages which activate one or more candidate RS resources of the set of candidate RS resources. Based on the one or more activation messages, the WTRU may receive the one or more candidate RS resources if LBT fails for RS transmission(s).

Dynamic Indication of Candidate RS Resources

In one embodiment, a WTRU may receive one or more indication messages from a gNB (e.g., via a MAC CE and/or a DCI) based on a set of candidate RS resources that are semi-statically configured and/or activated. For example, the WTRU may receive one or more indication messages indicating one or more candidate RS resources of the set of candidate RS resources. Based on the one or more indication messages, the WTRU may receive the one or more candidate RS resources if LBT fails for RS transmission(s).

Identical Configuration Between Candidate RS Resources and Reference RS Resources

In one embodiment, identical configurations may be supported/used for one or more RS resources and one or more candidate RS resources. The identical configurations may be based on one or more of following:

Bandwidth Part (BWP). In one embodiment, a RS resource and an associated candidate RS resource may be configured with an identical BWP ID.

Resource Type. In one embodiment, a RS resource and an associated candidate RS resource may be configured with an identical configuration for resource type. For example, if the RS resource is configured with a first resource type (e.g., aperiodic, semi-persistent or periodic), the associated candidate RS resource may be configured with the first resource type (e.g., aperiodic, semi-persistent or periodic). If the RS resource is configured with the second resource type (e.g., aperiodic, semi-persistent or periodic), the associated candidate RS resource may be configured with the second resource type (e.g., aperiodic, semi-persistent or periodic).

Resource Mapping. In one embodiment, a RS resource and an associated candidate RS resource may be configured with an identical resource mapping.

Power Control Offset. In one embodiment, a RS resource and an associated candidate RS resource may be configured with an identical power control offset and/or power control offset SS

Scrambling ID. In one embodiment, a RS resource and an associated candidate RS resource may be configured with an identical scrambling identity.

Periodicity and/or Offset (e.g., periodicityAndOffset and/or aperiodicTriggeringOffset). In one embodiment, a RS resource and an associated candidate RS resource may be configured with identical periodicity and/or offset.

Repetition on/off. In one embodiment, a RS resource and an associated candidate RS resource may be configured with an identical configuration for repetition on/off. For example, if the RS resource is configured with repetition on, the associated candidate RS resource may be configured with repetition on. If the RS resource is configured with repetition off, the associated candidate RS resource may be configured with repetition off.

RSs for QCL. In one embodiment, a RS resource and an associated candidate RS resource may be configured with identical reference RSs (e.g., one or more of CSI-RS, SSB and SRS) for one or more of QCL types (e.g., one or more of QCL Type A, B, C and D). For example, if the RS resource is configured with a first CSI-RS (e.g., for tracking) for QCL Type A and a second CSI-RS for QCL Type D, the associated candidate RS resource may be configured with the first CSI-RS for QCL Type A and the second CSI-RS for QCL Type D.

Number of RS Resources. In one embodiment, a number of one or more RS resources and a number of one or more candidate RS resources may be identical.

TRS info. In one embodiment, a RS resource and an associated candidate RS resource may be configured with an identical configuration for trs-Info. For example, if the RS resource is configured with trs-Info, the associated candidate RS resource may be configured with trs-Info. If the RS resource is configured without trs-Info, the associated candidate RS resource may be configured without trs-Info

Possible RS Types for Candidate RS Resources

In one embodiment, a WTRU may be configured, activated, and/or indicated with candidate RS resources and may receive RS transmission (e.g., failed RS transmission(s)) based on the candidate RS resources if LBT fails. One or more of following RSs may be used for candidate RS resources:
Synchronization Signals/Physical Broadcasting Channel (SSB/PBCH);
Channel State Information-Reference Signal (CSI-RS). For example, CSI-RS for one or more of CSI, beam management with repetition on/off and/or tracking, may be used;
Sounding Reference Signal (SRS). For example, SRS for one or more of codebook based, non-codebook based, beam management, and/or antenna switching, may be used;
Positioning Reference Signal (PRS);
Demodulation Reference Signal (DM-RS); and/or
Phase Tracking Reference Signal (PT-RS).

### RS Candidate(s) Based on Candidate RS Resource Set(s)

In one embodiment, a WTRU may be configured, activated, and/or indicated with one or more candidate RS resource sets in addition to the reference RS resource sets for transmission. The candidate RS resource sets may be associated to one or more of the reference RS resource sets for transmission. The WTRU may assume an explicit or implicit mapping between the reference RS resource sets and the candidate RS resource sets. As such, in case a reference RS resource set transmission is not accomplished due to the LBT failure at a gNB, the WTRU may expect to receive the associated candidate RS in the earliest consecutive RS transmission occasion, within the candidate RS resource set configuration.

In an example, the WTRU may be configured with one or more of following in the candidate CSI-RS resource config, e.g., CSI-ResourceConfig:
A RS downlink BWP, e.g., bwp-Id, for channel measurement, where it may be based on the associated reference RS resource set.
A RS resource set list of references to CSI-IM resources used for beam management and reporting, e.g., csi-IM-ResourceSetList.
A RS resource set ID used in the corresponding RS report config to refer to the candidate CSI-RS resource set, e.g., csi-ResourceConfigId.
A RS resource set list of references to SSB resources used for beam management and reporting, e.g., csi-SSB-ResourceSetList.
A RS resource set list of references to NZP CSI-RS resources used for beam management and reporting, e.g., nzp-CSI-RS-ResourceSetList. And/or
A RS time domain behavior of candidate RS resource set configuration, e.g., resourceType.

In another example, the WTRU may be configured with one or more of following in the candidate RS resource set, e.g., NZP-CSI-RS-ResourceSet:
RS resources associated with the RS Resource set, e.g., nzp-CSI-RS-Resources.
Indication to the application of the repetition, e.g., repetition.
Indication to the mapping of the antenna ports for the RS resources within the corresponding RS resource set, e.g., trs-Info.
The offset between the slot triggering the set of aperiodic candidate RS resources and the slot that the candidate RS resource sets are transmitted, e.g., aperiodicTriggeringOffset.
   The offset may be a relative offset based on a reference RS resource set. For example, if the WTRU is configured with a first offset for a reference RS resource set and a second offset for a candidate RS resource set. The actual offset of the candidate RS resource set may be a function of the first offset and the second offset, for example, actual offset=the first offset+the second offset.

In some examples, if the WTRU does not receive one or more of the configurations for a candidate RS resource set, the WYTRU may assume identical configurations with a reference RS resource set.

In one embodiment, the WTRU may identify the configuration of the candidate RS resource set(s) in association with the reference RS resource set(s). The configuration and/or indication may be based on one or more of following:
Explicit Indication.
   The WTRU may identify the associated candidate RS resource sets based on explicit indication. For example, for a RS resource set, an ID of a candidate RS resource set can be configured/activated or indicated by a gNB (e.g., via one or more of RRC, MAC CE, and/or DCI). If the associated RS resource set fails, the WTRU may use the candidate RS resource or the candidate RS resource set. The parameters that are different in the candidate RS resource set from the reference RS resource set may be configured semi-statically and/or dynamically (e.g., one or more of RRC, MAC CE, and/or DCI). In an example, the mapping of the antenna ports and/or repetition may be configured in the candidate RS resource set different from the reference RS resource set, as such they may be configured explicitly. In another example, the offset between the slot triggering the set of aperiodic candidate RS resource sets and the slot that the reference RS resource sets are transmitted may be configured explicitly.
Implicit Indication.
   The WTRU may identify the associated candidate RS resource sets based on implicit indication. For example, the WTRU may identify the associated candidate RS resource sets based on one or more operations/methods discussed herein. The WTRU may identify the parameters that are the same in the candidate RS resource sets based on the corresponding parameters in the reference RS resource sets. In an example, the RS resources associated with the candidate RS resource sets may be implicitly identified based on the RS resources in the corresponding reference RS resource sets. In another example, the mapping of the antenna ports and/or repetition may be configured in the candidate RS resource set the same as the reference RS resource set, as such WTRU may identify them implicitly. In an example, the WTRU may identify the associated candidate RS resource set if one or more of configured parameters in the candidate RS resource set are identical to one or more configured parameters in a reference RS resource set. The one or more configured parameters may include any of:
      Repetition on/off;
      Aperiodic triggering offset;
      TRS-info;
      QCL types and reference RSs; and/or
      The number of configured RS resources for a RS resource set.

In one embodiment, the WTRU may be configured with one or more of following in the RS resources of the candidate RS resource sets, e.g., NZP-CSI-RS-Resource:
RS resource mapping to define the number of RS resource ports, density, CDM-type, OFDM symbol, and subcarrier occupancy, e.g., resource mapping.
RS resource power control offsets, e.g., powerControlOffset and/or powerControlOffsetSS. The power control offset may be a relative offset based on a reference RS resource. For example, if the WTRU is configured with a first power control offset for a reference RS resource and a second power control offset for a candidate RS resource. The actual power control offset of the candidate RS resource may be a function of the first offset and the second offset, e.g., actual power control offset=the first power control offset+the second power control offset.
RS resource scrambling ID, e.g., scramblingID.
RS resource periodicity and slot offset for periodic and semi-persistent CSI-RS Resources, e.g., periodicityAndOffset. The periodicity and/or the slot offset may be relative values based on a reference RS resource. For example, the WTRU may be configured with a first slot offset for a reference RS resource and a second slot offset for a candidate RS resource. The actual slot offset of the candidate RS resource may be a function of the first slot offset and the second slot offset, e.g., actual slot offset=the first slot offset+the second slot offset. In another example, the WTRU may be configured with a first periodicity for a reference RS resource and a second periodicity for a candidate RS resource. The actual periodicity of the candidate RS resource may be a function of the first periodicity and the second periodicity. In an example, the WTRU may receive a configured slot offset without periodicity. In this case, the WTRU may apply the periodicity of the reference RS resource.
RE resource reference to the TCI-State including the QCL source RS(s) and the corresponding QCL type(s), e.g., qcl-InfoPeriodicCSI-RS.

In some examples, if the WTRU does not receive one or more of the configurations for a candidate RS resource, the WTRU may assume identical configurations with a reference RS resource.

In one embodiment, the WTRU may identify the configuration of the RS resources configured in the candidate RS resource set(s) in association with the RS resources in the reference RS resource set(s). The configuration and/or indication may be based on one or more of following:
Explicit Indication.
   The WTRU may identify the associated RS resources in the candidate RS resource sets based on explicit indication. For example, for a RS resource set in an associated RS resource set, an ID of a candidate RS resource of the candidate RS resource set can be configured/activated or indicated by a gNB (e.g., via one or more of RRC, MAC CE, and/or DCI). If the associated RS resource or the associated RS resource set fails, the WTRU may use the candidate RS resource or the candidate RS resource set. The parameters that are different in the RS resources of the candidate RS resource set from the RS resources in the reference RS resource set may be configured semi-statically and/or dynamically (e.g., one or more of RRC, MAC CE, and/or DCI). In an example, the resource mapping in time and frequency may be configured for the RS resources in the candidate RS resource set different from the RS resources in the reference RS resource set, as such they may be configured explicitly. In another example, the periodicity and offset for the RS resources in the candidate RS resource set may be configured explicitly.
Implicit Indication.
   The WTRU may identify the associated RS resources in the candidate RS resource sets based on implicit indication. For example, the WTRU may identify the RS resources configured in the candidate RS resource sets based on one or more operations/methods discussed herein. In an example, the WTRU may be configured with the TCI-states for providing the QCL source and QCL type for RS resources in candidate RS resource sets based on the TCI-states for the RS resources in the reference RS resource sets. As such, WTRU may identify the TCI-state for the RS resources in the candidate RS resource sets implicitly. In another example, the periodicity and offset for the RS resources in the candidate RS resource set may be configured implicitly and based on a predefined/calculated/determined relative delay from the RS resources in the reference RS resource sets. In an example, the WTRU may identify an associated RS resource based on the configured order. For example, a first candidate RS resource of a candidate RS resource set may be associated with a first reference RS resource of an associated reference RS resource set and a second candidate RS resource of a candidate RS resource set may be associated with a second reference RS resource of an associated reference RS resource set.

### RS Candidate(s) Based on Candidate RS Resource(s)

In various embodiments, the configuration(s) discussed herein may be interchangeably used with one or more of: BWP, resource type, resource mapping, power control offset, scrambling ID, periodicity and/or offset (e.g., periodicityAndOffset and/or aperiodicTriggeringOffset), repetition on/off, reference RSs for QCL types (e.g., one or more of QCL Type A, B, C, and/or D), the number of RS resources, and/or TRS info.

In one embodiment, a WTRU may be configured, activated, and/or indicated with one or more candidate RS resources in addition to the reference RS resource sets for transmission. The candidate RS resources may be associated to one or more of the reference RS resources for transmission. The WTRU may assume an explicit or implicit mapping between the reference RS resources and the candidate RS resources. As such, in case an RS transmission is not accomplished due to the LBT failure at gNB, the WTRU may expect to receive the associated candidate RS resource in the earliest consecutive RS transmission occasion, within the candidate RS resource configuration.

In an example, the WTRU may be configured with one or more of following in the candidate RS resources, e.g., NZP-CSI-RS-Resource:
RS resource mapping to define the number of RS resource ports, density, CDM-type, OFDM symbol, and subcarrier occupancy, e.g., resource mapping.
RS resource power control offsets, e.g., powerControlOffset and/or powerControlOffsetSS.
RS resource scrambling ID, e.g., scramblingID.
RS resource periodicity and slot offset for periodic and semi-persistent CSI-RS Resources, e.g., periodicityAndOffset.
RE resource reference to the TCI-State including the QCL source RS(s) and the corresponding QCL type(s), e.g., qcl-InfoPeriodicCSI-RS.

Candidate RS Association

In one embodiment, the WTRU may identify the configuration of the candidate RS resources in association with the reference RS resources. The configuration and/or indication may be based on one or more of following:
Explicit Indication.
   The WTRU may identify the associated candidate RS resources based on explicit indication. The parameters that are different in the candidate RS resources from the reference RS resources may be configured semi-statically and/or dynamically (e.g., one or more of RRC, MAC CE, and/or DCI). In an example, the resource mapping in time and frequency may be configured for the candidate RS resources different from the reference RS resources, as such they may be configured explicitly. In another example, the periodicity and offset for the RS resources in the candidate RS resources set may be configured explicitly.
Implicit Indication.
   The WTRU may identify the associated candidate RS resources based on implicit indication. For example, the WTRU may identify the candidate RS resources based on one or more operations/methods discussed herein. In an example, WTRU may be configured with the TCI-states for providing the QCL source and QCL type for candidate RS resources based on the TCI-states for the reference RS resources. As such, the WTRU may identify the TCI-state for the candidate RS resources implicitly. In another example, the periodicity and offset for the candidate RS resources may be configured implicitly and based on a predefined/calculated/determined relative delay from the reference RS resources.

Dynamic Determination of One or More Configurations

In one embodiment, a WTRU may not be configured with one or more of configurations for one or more candidate RS resources associated with multiple RS resources/resource sets. If one or more of associated RS resources of the multiple RS resources/resource sets fail, the WTRU may apply or assume identical configurations for the one or more candidate RS resources with the one or more of associated RS resources. For example, if a reference RS resource configured with a first configuration fails, the WTRU may receive a candidate RS resource with the first configuration.

In one embodiment, a WTRU may be configured with a candidate RS resource with multiple configurations for multiple reference RS resources. For example, the WTRU may be configured with a candidate RS resource with a first configuration for a first reference RS resource and a second configuration for a second reference RS resource. Based on a failed resource, the WTRU may determine to use the first configuration or the second configuration for receiving the candidate RS resource. For example, if the first reference RS resource fails, the WTRU may receive a candidate RS resource with the first configuration. If the second reference RS resource fails, the WTRU may receive a candidate RS resource with the second configuration.

In one embodiment, a WTRU may apply relative configurations of candidate RSs on top of configurations of reference RSs. For example, the relative offset for the candidate RS resources can be determined based on one or more operations/methods discussed herein.

In an example, the relative offset for the candidate RS resources may be configured semi-statically. As such, the actual offset for the candidate RS resources may be calculated/determined based on the consecutive failures of the RS resource transmissions. For example, if the WTRU is configured with a first slot offset for a reference RS resource and a second slot offset for a candidate RS resource. The actual slot offset of the candidate RS resource may be a function of the first slot offset and the second slot offset, e.g., actual slot offset=the first slot offset+the second slot offset.

In another example, the relative offset for the candidate RS resources may be configured dynamically based on the offset that is configured per RS resource. For example, the WTRU may be configured with a candidate RS resource with a first relative offset for a first reference RS resource with a first offset and a second relative offset for a second reference RS resource with a second offset. Based on a failed resource, the WTRU may determine to use the first offset/the first relative offset or the second offset/the second relative offset for receiving the candidate RS resource. For example, if the first reference RS resource fails, the WTRU may receive a candidate RS resource with an offset determined based on the first offset and the first relative offset (e.g., the offset=the first offset+the first relative offset). If the second reference RS resource fails, the WTRU may receive a candidate RS resource with an offset determined based on the second offset and the second relative offset (e.g., the offset=the second offset+the second relative offset).

Dynamic Determination Based on a Number of Failures

In one embodiment, a WTRU may be configured/indicated with a candidate RS resource with multiple configurations for a number of RS/LBT failures. For example, the WTRU may be configured with a candidate RS resource with a first configuration and a second configuration. Based on a number of failures, the WTRU may determine to use the first configuration or the second configuration for receiving the candidate RS resource. For example, if the number of failures is smaller than (or equal to) M, the WTRU may receive a candidate RS resource with the first configuration. If the number of failures is larger than M, the WTRU may receive a candidate RS resource with the second configuration. The M may be predefined, configured and/or indicated by a gNB (e.g., based on one or more of RRC, MAC CE, and/or DCI).

Dynamic Determination Based on Reference RS Configurations

In one embodiment, a WTRU may be configured/indicated with multiple candidate RS resources for multiple reference RSs. For example, the WTRU may be configured with a first candidate RS resource with/for a first configuration.

In an example, the WTRU may be configured with a second candidate RS resource with/for a second configuration. Based on a failed reference RS resource, the WTRU may determine to use the first candidate RS resource or the second candidate RS resource for measurement. For example, if a failed RS resource is configured/indicated with the first configuration, the WTRU may determine to use the first candidate RS resource with the first configuration. If the failed RS resource is configured/indicated with the second configuration, the WTRU may determine to use the second candidate RS resource with the second configuration.

In another example, the WTRU may be configured with a first candidate RS resource and a second candidate RS resource. Based on a failed reference RS resource, the WTRU may determine to use the first candidate RS resource or the second candidate RS resource for measurement. For example, if a failed RS resource is configured/indicated with the first configuration (e.g., a first number of antenna ports) which is smaller than (or equal to) a threshold (e.g., 8), the WTRU may determine to use the first candidate RS resource. If the failed RS resource is configured/indicated with the second configuration (e.g., a second number of antenna ports) which is larger than the threshold (e.g., 8), the WTRU may determine to use the second candidate RS resource. The threshold may be based on one or more of predefined values, semi-statically or dynamically configured/indicated values by a gNB (e.g., by using one or more of RRC, MAC CE and DCI) and WTRU reported values (e.g., by WTRU capability). Multiple thresholds may be used to determine a candidate RS resources among multiple candidate RS resources.

Prioritization of Failed RS Resources

In one embodiment, if the number of one or more failed RS resources exceeds N (e.g., the number of candidate RS resources), the WTRU may determine to receive one or more candidate RS resources based on one or more of following:
Not receiving/transmitting RSs. For example, if number of one or more failed RS resources exceeds N (e.g., number of candidate RS resources), the WTRU may not receive the one or more candidate RS resources which are associated with the one or more failed RS resources.
Receiving/transmitting RSs for a part of failed RS resources (e.g., by selecting a part of the one or more failed RS resources). For example, if number of one or more failed RS resources exceeds N (e.g., number of candidate RS resources), the WTRU may receive candidate RS resources for a part of the one or more failed RS resources. The WTRU (and/or a gNB) may determine a set of failed RS resources of the one or more failed RS resources. The WTRU may determine the set of failed RS resources of the one or more failed RS resources based on one or more of following:
   RS ID. In an example, a failed RS resource with a lower or higher RS resource ID may be determined. For example, if a first RS resource with a first resource ID and a second RS resource with a second resource ID fail, the WTRU may determine the first RS resource based on the first resource ID and receive a candidate RS resource for the first RS resource.
   RS order. In an example, a firstly (or lastly) configured RS resource may be prioritized than other RS resources. For example, if a first RS resource with a first order and a second RS resource with a second order fail, the WTRU may determine the first RS resource based on the first order and receive a candidate RS resource for the first RS resource.
   Transmission type. In an example, a first transmission type (e.g., periodic and/or semi-persistent) may be prioritized than a second transmission type (e.g., semi-persistent and/or aperiodic). For example, if a first RS resource with a first transmission type and a second RS resource with a second transmission type fail, the WTRU may determine the first RS resource based on the first transmission type and receive a candidate RS resource for the first RS resource.
   BWP ID, Scrambling ID, serving cell ID, and/or physical cell ID. In an example, an RS resource with a lower or higher BWP ID, Scrambling ID, serving cell ID, and/or physical cell ID may be prioritized. For example, if a first RS resource with a first BWP ID and a second RS resource with a second BWP ID fail, the WTRU may determine the first RS resource based on the first BWP ID and receive a candidate RS resource for the first RS resource.
   Number of ports. In an example, a first RS resource with a larger/smaller number of antenna ports may be prioritized than a second RS resource with a smaller/larger number of antenna ports. For example, if a first RS resource with a first number of antenna ports and a second RS resource with a second number of antenna ports (may be smaller than the first number of antenna ports) fail, the WTRU may determine the first RS resource based on the first number of antenna ports and receive a candidate RS resource for the first RS resource.
   Link type. In an example, a first RS resource with a first link type (e.g., DL or UL) may be prioritized than a second RS resource with a second link type (e.g., UL or DL). For example, if a first RS resource with a first link type and a second RS resource with a second link type fail, the WTRU may determine the first RS resource based on the first link type and receive a candidate RS resource for the first RS resource.
   Time/frequency resources. In an example, a first RS resource with a larger/smaller time/frequency resources may be prioritized than a second RS resource with a smaller/larger number of time/frequency resources.
   Periodicity/offset. For example, a first RS resource with a larger/smaller periodicity/offset may be prioritized than a second RS resource with a smaller/larger periodicity/offset.
      The N may be predefined, configured, and/or indicated by a gNB (e.g., based on one or more of RRC, MAC CE, and/or DCI).

### Supplementary Cell(s) for RS Transmission

In various embodiments, PCell may be interchangeably used with SCell and PScell, but consistent with this invention.

In one embodiment, a WTRU may be configured, activated and/or indicated with one or more RS resources in a first frequency resource and one or more candidate RS resources in a second frequency resource. Based on LBT operation, whether to use the one or more RS resources or the one or more candidate RS resources for RS transmission may be determined. In an example, the WTRU may use LBT before its RS transmission. Based on the LBT, the WTRU may determine that channel for RS transmission is occupied or not. For example, if the channel is not occupied, the WTRU may determine to receive the one or more RS resources in the first frequency resource. If the channel is occupied, instead of receiving RSs in the one or more RS resource, the WTRU may determine to receive the one or more candidate RS resources in the second frequency resource. The first frequency resource and the second frequency resource may be one or more of following:

Unlicensed band and licensed band. In one embodiment, the first frequency resource may be unlicensed band and the second frequency resource may be licensed band. For example, if the channel is not occupied, the WTRU may receive the one or more RS resources in the unlicensed band. If the channel is occupied, the WTRU may receive the one or more candidate RS resources in the licensed band

Normal link and supplementary link. In one embodiment, the first frequency resource may be a normal link and the second frequency resource may be a supplementary link. For example, if the channel is not occupied, the WTRU may receive the one or more RS resources in the normal link. If the channel is occupied, the WTRU may receive the one or more candidate RS resources in the supplementary link

A first cell and a second cell. In one embodiment, the first frequency resource may be a first cell and the second frequency resource may be a second cell. For example, if the channel is not occupied, the WTRU may receive the one or more RS resources in the first cell. If the channel is occupied, the WTRU may receive the one or more candidate RS resources in the second cell. In some cases, the first cell may be an SCell or PScell and the second cell may be a PScell or PCell. The WTRU may be configured with one or more serving cell IDs and/or one or more physical cell IDs to indicate the first cell and/or the second cell. The configuration or indication may be per WTRU, RS resource set and/or RS resource. The indication may include one or more of following:
Semi-static configuration. For example, the WTRU may be configured with a serving cell ID and/or a physical cell ID in configurations of the one or more RS resources (e.g., via RRC). Based on the serving cell ID and/or the physical cell ID, the WTRU may receive the one or more candidate RS resources in the cell with the serving cell ID and/or the physical cell ID.
Dynamic indication. For example, the WTRU may be indicated with a serving cell ID and/or a physical cell ID for the one or more candidate RS resources (e.g., via MAC CE and/or DCI). Based on the serving cell ID and/or the physical cell ID, the WTRU may receive the one or more candidate RS resources in the cell with the serving cell ID and/or the physical cell ID.

A first BWP and a second BWP. In one embodiment, the first frequency resource may be a first cell and the second frequency resource may be a second cell. For example, if the channel is not occupied, the WTRU may receive the one or more RS resources in the first cell. If the channel is occupied, the WTRU may receive the one or more candidate RS resources in the second cell. The WTRU may be configured with one or more BWP IDs to indicate the first BWP and/or the second BWP. The configuration or indication may be per WTRU, RS resource set and/or RS resource. The indication may be one or more of following:
Semi-static configuration. For example, the WTRU may be configured with a BWP ID in configurations of the one or more RS resources (e.g., via RRC). Based on the BWP ID, the WTRU may receive the one or more candidate RS resources in the BWP with the BWP ID.
Dynamic indication. For example, the WTRU may be indicated with a BWP ID for the one or more candidate RS resources (e.g., via MAC CE and/or DCI). Based on the BWP ID, the WTRU may receive the one or more candidate RS resources in the BWP with the BWP ID.

### Adaptation of LBT for RS Transmission

In one embodiment, a WTRU and/or a gNB may support (or use, or be configured with) one or more of following channel access priority class:

TABLE 1
Channel Access Priority Class and Related Parameters

| | | Minimum | Maximum | Channel | | Allowed |
|---|---|---|---|---|---|---|
| Channel Access | Sensing slot | contention | contention | Occupancy | | contention window |
| Priority Class (p) | durations | window for p | window for p | Time for p | | sizes for p |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |

255, 511, 1023}

In an example, as shown in Table 1, a channel access priority class may indicate a respective (or a different) time duration for an LBT operation (e.g., a sensing slot duration).

In one embodiment, a WTRU and a gNB may support one or more of following LBT categories for unlicensed band operation. For example, an LBT category may indicate a respective (or a different) LBT behavior (e.g., LBT with or without random back-off).
Category 1: Immediate transmission after a short switching gap
   This is used for a transmitter to immediately transmit after a switching gap inside a COT.
   The switching gap from reception to transmission is to accommodate the transceiver turnaround time and is no longer than 16 μs.
Category 2: LBT without random back-off
   The duration of time that the channel is sensed to be idle before the transmitting entity transmits is deterministic.
Category 3: LBT with random back-off with a contention window of fixed size
   The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.
Category 4: LBT with random back-off with a contention window of variable size
   The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

In one embodiment, a WTRU and/or a gNB may apply different channel access priority class and/or LBT categories to utilize a smaller sensing slot duration, and/or a smaller contention window size, based on one or more of following:

RS type. For example, if the WTRU receives RS transmission via one or more RS resources, the WTRU may apply a first priority class and/or a first LBT category. If the WTRU receives RS transmission via candidate RS resources, the WTRU may apply a second priority class and/or a second LBT category.

Number of LBT failures. For example, if the WTRU receives RS transmission without LBT failure or with X LBT failures which is smaller than (or equal to) Y, the WTRU may apply a first priority class and/or a first LBT category. If the WTRU receives RS transmission with X LBT failures which is larger than Y, the WTRU may apply a second priority class and/or a second LBT category. In an example, only consecutive LBT failures may be used for the determination of X. In some cases, Y may be based on a predetermined value and/or an indicated value by the gNB.

Priority indication. For example, if the WTRU receives RS transmission with a first priority indication, the WTRU may apply a first priority class and/or a first LBT category. If the WTRU receives RS transmission with a second priority indication, the WTRU may apply a second priority class and/or a second LBT category. In another example, if the WTRU receives one or more PDSCHs with a first priority indication, the WTRU may apply a first priority class and/or a first LBT category. If the WTRU receives one or more PDSCHs with a second priority indication, the WTRU may apply a second priority class and/or a second LBT category.

### RS Transmission Failure Indication or Identification

In various embodiments, an RS instance may refer to a RS in a specific time symbol or set thereof, or within a specific time interval.

Presence of RS Instance and Associated Behavior

In one embodiment, a WTRU may determine whether a RS is present or not in at least one instance or time interval using at least one solution described below. Upon determining whether RS is present for the at least one instance, the WTRU may use this determination for at least one of the following purposes:
Measurement (e.g. CSI, L1-RSRP, L1-SINR, RSRP, RSRQ, SINR) based on the RS;
Synchronization and tracking (e.g. frequency or time domain);
QCL determination;
Determination of in-sync or out-of-sync for radio link monitoring;
Starting or stopping timer and/or updating or resetting counters for radio link monitoring; and/or
Starting or stopping timer and/or updating or resetting counters for beam failure recovery and/or contention-based/non-contention-based RACH procedure.

In various embodiments, for any of the above purposes, the WTRU may perform any of:
Only include measurements from RS instances that it determines present and exclude RS instances that it determines not to be present;
Replace an RS instance determined not to be present with at least one instance of RS candidate (e.g., as described in above);
When filtering and/or averaging over multiple RS is performed, not take into account any of the previous measurements over past RS instances (e.g., erase memory);
Restart or stop a timer and/or reset a counter for the detection of radio link problem (e.g., T310, N310) when in-sync or out-sync cannot be detected for an RS instance determined as not present; and/or
Restart or stop a timer and/or reset a counter for beam failure recovery and/or contention-based/non-contention-based RACH procedure when an RS instance determined as not being present.

RS Presence Determination Based on Explicit Indication

In one embodiment, the WTRU may determine whether a RS is present or not based on an explicit indication. The indication may be received from MAC CE or a UE-specific or group-common DCI. The indication may include at least one of:
At least one time interval over which the WTRU should consider the RS not present (or present). A time interval may be defined by a starting symbol or slot and an ending symbol or slot. The starting symbol and/or ending symbol may be indicated with respect to the timing of the PDCCH carrying the DCI containing the indication. Alternatively, the starting and/or ending symbol may be indicated with respect to a time window explicitly included in the signaling.
At least one frequency interval over which the WTRU should consider the RS not present (or present). A frequency interval may be defined by a starting RB, RBG or subband and an ending RB, RBG or subband. The starting RB, RBG or subband and/or ending RB, RBG or subband may be indicated with respect to the frequency location of the PDCCH carrying the DCI containing the indication. Alternatively, the starting and/or ending RB, RBG or subband may be indicated with respect to a frequency resources explicitly included in the signaling.
A type of RS;
At least one resource ID;
At least one resource set ID; and/or
A set of instances for which the RS is not present (or present). For example, a set of instances may be indicated by a number of instances occurring up to the time of reception of the signaling (e.g., the starting symbol of the PDCCH carrying the DCI that contains the indication).

The explicit indication may indicate whether a RS is present or not present for more than one RS. For example, a first value of a field of the explicit indication may indicate that a first RS is present and a second RS is not present, a second value may indicate that a first RS is not present and a second RS is present, and so on. For example, the second RS may be one of a candidate RS resource that the WTRU uses in replacement of the RS indicated as not present.

RS Presence Determination Based on Measurement or Implicit Indication

In one embodiment, the WTRU may determine whether a first instance of a first RS is present or not based on at least one measurement. The WTRU may take the at least one measurement on at least one of the following: resources corresponding to the first instance of the first RS, and/or resources corresponding to a second instance of a second RS associated with the first RS.

In one embodiment, determination based on a measurement of a second RS may enable the network to implicitly signal that the first RS was not transmitted, by transmitting the second RS.

In various embodiments, a measurement (e.g., RS measurement) discussed herein may include any of: reference signal received power (RSRP) or received quality (RSRQ) for the corresponding RS including L1-RSRP; signal-to-interference plus noise ratio (SINR) including L1-SINR; and/or received signal strength indicator (RSSI).

In various embodiments, the WTRU may determine that a first RS instance is present (or not present) based on at least one of the following conditions: measurement taken over resource of the first instance of the first RS is above (or below) a first threshold; and/or measurement taken over resource of an instance of the second RS is below (or above) a second threshold. In an example, the first threshold and/or the second threshold may be pre-defined, or configured by higher layers, or a function of another measurement. For example, the first threshold may be a function of an RSSI of a carrier/a network entity.

In various embodiments, the association or relationship between the first RS and the second RS may be configured by higher layers or pre-defined. For example, such configuration may include any of:
The first RS and second RS may be on a first serving cell and a second serving cell (and/or bandwidth part(s)), respectively;
The first RS and second RS may be scrambled using a first scrambling identity and a second scrambling identity, respectively;
The first RS and second RS may be of a first type and a second type, respectively;
The first RS and second RS may be quasi-colocated for a given type with a first reference (or synchronization) signal and a second reference (or synchronization) signal, respectively; and/or
The time difference between the first RS and second RS instance may be configured to a certain value or to be within a range of possible values. For example, a first RS instance may be associated with a second RS instance if the time of the first RS instance is within a time interval. The time interval may depend on the time T2 of the second RS instance. For example, the time interval may start at time T2-Td and end at time T2, where Td is a duration that may be pre-defined or configured for the second RS instance.

In one embodiment, the WTRU may perform a RSRP measurement for a second RS scrambled using parameter S2 and received at time T2. If the RSRP measurement for this second RS is above a threshold, the WTRU determines that any instance of a first RS scrambled using parameter S1 and received at time T1, where T1 is between T2-Td and Td, is not present. The parameters S1, S2 and Td may be configured by higher layers.

Measurement Reset Indication

In one embodiment, the WTRU may determine to reset WTRU measurement. The reset may be applied to one or more of following:

CSI measurement. For example, the WTRU may not consider previous RS measurement for CSI before the determination of the reset.

RRM/RLM measurement. For example, the WTRU may not consider previous RS measurement for RRM/RLM before the determination of the reset.

Beam failure monitoring. For example, the WTRU may not consider previous RS measurement for beam failure recovery for beam failure detection and new beam selection before the determination of the reset.

Counters and/or timers associated with beam failure recovery. For example, the WTRU may reset counters and/or timers associated with beam failure recovery after determination of the reset.

Counters and/or timers associated with contention-based or non-contention-based RACH procedure. For example, the WTRU may reset counters and/or timers associated with contention-based/non-contention-based RACH procedure after a determination of the reset.

In various embodiments, the reset (e.g., measurement reset) may be based on one or more of following:

Explicit indication from a network entity. For example, the gNB may indicate to the WTRU to reset WTRU measurement due to LBT. The indication may be based on one or more of MAC CE and/or DCI. The indication may include one or more of following:
One or more of RS resource/resource set IDs;
One or more of CSI report config IDs; and/or
One or more of resource config IDs.

WTRU determination. For example, the WTRU may determine to reset WTRU measurement. The WTRU determination may be based on one or more of following:
RS type. For example, if the WTRU receives RS transmission via one or more RS resources, the WTRU may not determine the reset. If the WTRU receives RS transmission via candidate RS resources, the WTRU may determine the reset; and/or
RS presence. For example, if the WTRU does not detect RS presence in X resources which is smaller than (or equal to) Y, the WTRU may not determine the reset. If the WTRU does not detect RS presence in X resources which is larger than Y, the WTRU may determine the reset. For example:
   Only consecutive RS resources may be used for the determination of X; and/or
   Y may be based on a predetermined value and/or an indicated value by the gNB.

### Rate Matching of RS Candidate(s) for Other WTRUs

A resource element (RE) which is used or configured for a reference signal (RS) candidate resource (RSCR) may be punctured or rate-matched around for a downlink or an uplink transmission when it collides with an RE used or scheduled for a downlink (e.g., PDSCH) or an uplink transmission (e.g., PUSCH). In various embodiments, an RE which may be punctured or rate-matched around may be referred to as muted RE, RE muting, and/or zero power RE.

A set of REs for the RE muting for a downlink or an uplink transmission may be determined based on one or more of following, wherein the set of muted REs may be configured based on the unit of at least one of reference signal resource, RE, resource block (RB), symbol, OFDM symbol, and/or slot. A set of REs for the RE muting may be interchangeably used with RE muting pattern and a set of muted REs.
Higher layer configuration
   A set of REs for the RE muting may be configured for a set of time resources. For example, a first set of REs for the RE muting may be associated with a first set of time resources (e.g., a first set of slots) and a second set of REs for the RE muting may be associated with a second set of time resources (e.g., a second set of slots)
Dynamic indication
   One or more sets of muted REs may be configured and one of the sets of muted REs may be indicated in the associated DCI for PDSCH or PUSCH, wherein each set of muted REs may be associated with an index and the index may be indicated in the associated DCI
      The index may be explicitly indicated in the DCI
      The index may be implicitly indicated via an RNTI which may be used for a DCI transmission
Implicit determination
   One or more sets of muted REs may be configured and one of the sets of muted REs may be determined based on a time index, wherein the time index may be at least one of slot index, OFDM symbol index, and/or frame index
   A set of muted REs may be configured or determined based on the RSCR configuration. For example, the configured RSCR REs may be determined as the muted REs for a PDSCH or a PUSCH transmission

In one embodiment, a set of muted REs may be configured, used, triggered, or determined for a PDSCH or a PUSCH based on an LBT failure (or status of LBT) in an associated slot, symbol, and/or a time window. For example, status of LBT (e.g., LBT success or LBT failure) of a first slot may determine whether the set of muted REs may be triggered or not in a second slot. LBT failure may be interchangeably used with DTX, dropped signal, no signal transmission, and zero power signal. One or more of following may apply:
A second slot may be located later than a first slot, wherein slot may be interchangeably used with time occasion
A first slot may include a measurement reference signal (e.g., periodic RS) and a second slot may include an associated reference signal candidate resource (RSCR)
A periodic measurement signal (e.g., SSB, CSI-RS, TRS) may be configured for a measurement and a WTRU determines LBT failure of the periodic measurement signal on each occasion. If the WTRU determines LBT failure of the periodic measurement signal in a first time occasion (e.g., symbol or slot), the WTRU may trigger, activate, or use a set of muted REs in an associated time occasion for a signal transmission (e.g., PDSCH or PUSCH)
A WTRU may determine LBT status (e.g., LBT failure or LBT success) based on one or more of following:
   Reception of a PDCCH. For example, a WTRU may determine “LBT success” if the WTRU detects at least one of DCI in a time occasion (e.g., symbol or slot). Otherwise, the WTRU may determine “LBT failure” for the time occasion
      A common DCI for LBT failure detection may be transmitted in each time occasion, wherein the common DCI may be monitored in a common search space
   Reception of a reference signal. For example, a WTRU may determine “LBT success” if the WTRU detect an energy level of the reference signal above a threshold in a time occasion. Otherwise, the WTRU determine “LBT failure” for the time occasion, wherein the reference signal may be a reference signal configured or indicated to be transmitted in the time occasion
      The threshold value may be determined based on reference signal types (e.g., CSI-RS for CSI feedback or CSI-RS for beam management)
   An indication. For example, a gNB or a WTRU may indicate LTB failure of a time occasion (e.g., a first time occasion) in a later time occasion (e.g., a second time occasion)
      LBT failure may be explicitly indicated in a DCI (e.g., group-DCI). For example, a group common PDCCH may be used for the indication
      LBT failure may be implicitly indicated based on an indication of channel occupancy indication. For example, a WTRU or a gNB may indicate a channel occupancy indication at the beginning of the slot of the time window occupied by the WTRU or the gNB.

In one embodiment, a WTRU may receive an indication of the RE muting pattern for a PDSCH reception or a PUSCH transmission.
The indication may be received by the WTRU in the associated DCI used for PDSCH and PUSCH scheduling
The indication may be received by the WTRU in a group-common PDCCH, wherein the group-common PDCCH may be received in an associated slot for a PDSCH or a PUSCH
   The associated slot may be different from the slot where the PDSCH may be received or the PUSCH may be transmitted.

### Multiple QCL Type-D Configuration

In various embodiments, RS reception may be interchangeably used with RS transmission, control channel (e.g., PDCCH, PUCCH, or Physical Sidelink Control Channel (PSCCH)) reception/transmission, and/or shared channel (e.g., PDSCH, PUSCH, or Physical Sidelink Shared Channel (PSSCH)) reception/transmission, but still consistent with this invention.
A WTRU may expect to receive a RS on a different spatial beam when transmission of that RS is prevented due to LBT failure. For example, a WTRU may expect to receive a P-TRS transmission prevented due to LBT failure on a different pre-configured beam.
The use of a different spatial beam (e.g., when a RS transmission is prevented due to LBT failure) may be activated by RRC signaling or MAC CE signaling. Alternatively, spatial beam switching operation may be configured by RRC signaling and/or dynamically indicated to activate by DCI or MAC-CE (considering the likelihood of preventing RS transmissions due to LBT failures). In one embodiment, a WTRU may implicitly indicate to enable the use of different spatial beams for RS transmission (prevented due to LBT failure) with enabling a beam-based LBT procedure.
The beam switching for RS reception may be performed by configuring a WTRU with multiple QCL Type-D source RSs for the expected RS transmission (e.g., by the gNB).
   For example, a WTRU may be configured with two QCL Type-D RSs for RS reception, i.e., one primary QCL Type-D RS and a secondary QCL Type-D RS. In the case of one or several RS transmission attempts are prevented due to LBT failures, a WTRU or a set of WTRUs may expect to receive RS with a different beam identified by the secondary QCL Type-D RS the WTRU or set of WTRUs are configured with.
   For example, a WTRU may be configured with two QCL Type-D RSs for RS reception, i.e., one primary QCL Type-D RS and a secondary QCL Type-D RS. The WTRU may measure the primary QCL Type-D RS. Based on the measurement, the WTRU may determine whether to use the primary RS or the secondary RS.
      For example, if the WTRU measurement is larger than (or equal to) a threshold Z, the WTRU may apply the primary RS as QCL Type-D reference for RS reception. If the WTRU measurement is smaller than the threshold Z, the WTRU may apply the secondary RS as QCL Type-D reference for RS reception.
      The measurement may be based on one or more of following:
         CQI;
         RSRP and/or L1-RSRP;
         SINR and/or L1-SINR;
         RSSI; and/or
         RSRQ.
      The measurement of the primary RS may be prioritized than the secondary RS. For example, the measured quality X and additional value Y may be added for comparison for the primary RS (e.g., if X+Y>Z). For the measurement of the secondary RS, the measure quality X′ may be used without Y or with different value Y′ may be used with the same threshold Z or a different threshold Z′ (e.g., X′+Y′>Z, X′>Z, X′+Y′>Z′ or X′>Z′)
      The threshold Z and/or Z′ may be based on one or more of predefined values, configured/indicated values by a gNB and reported values by the WTRU (e.g., WTRU capability)
To configure primary and secondary QCL Type-D RSs for RS reception by the WTRU, RS reception for example, the RS expected to be received could be configured with two TCI states. Each TCI state indicates different RS as the QCL Type-D source or reference RS. For example, two different SSBs may be configured as the source RSs in each TCI states. The WTRU may determine whether to use the primary TCI state or the second TCI state based on whether RS is prevented and/or WTRU measurements.
In one embodiment, a WTRU may expect to receive a periodic RS prevented transmitting due to LBT failure as an aperiodic RS Type-D QCLed with secondary source RS. For example, upon detection of the prevention of the transmission of a periodic RS due to LBT failure, a WTRU may expect to receive an aperiodic RS Type-D QCLed with the secondary source RS. The WTRU may determine whether to use the periodic RS or the aperiodic RS based on whether the periodic RS is prevented and/or WTRU measurements of the periodic RS.
In one embodiment, when RS transmissions are prevented due to LBT failures, a WTRU may be configured to receive the RS transmitted on multiple transmission opportunities. A subset of multiple transmission opportunities is expected to be Type-D QCLed with primary QCL Type-D source RS and the remaining transmission opportunities are expected to be Type-D QCLed with secondary QCL Type-D RS.

### Receiver Aided LBT Type Configuration/Indication

In one embodiment, a WTRU may be configured/indicated from a gNB to measure the interference. The WTRU may report the measure interference back to the gNB prior to LBT procedure at the gNB. The gNB request may be based on one or more of following:
Transmission type
   For example, the WTRU may be configured/indicated with one or more of transmission types for receiver aided LBT operation. Based on the configured/indicated one or more of transmission types, the WTRU may assess the channel and report the channel assessment to the gNB. The one or more of transmission types may be based on one or more of following:
      Control channel (one or more of PDCCH, PUCCH, PSCCH);
      Shared channel (one or more of PDSCH, PUSCH, PSSCH);
      RS transmission (DL RS (possibly including SS/PBCH block) and/or UL RS); possibly including one or more RS types; and/or
      Random access channel (PRACH).
Link type
   For example, the WTRU may be configured/indicated with one or more of link types for receiver aided LBT operation. Based on the configured/indicated one or more of link types, the WTRU may assess the channel and report the channel assessment to the gNB. The one or more of link types may be based on one or more of following:
      Downlink
      Uplink
      Sidelink
Time and/or frequency resources for receiver aided LBT
   For example, the WTRU may be configured/indicated with one or more of time/frequency resources for receiver aided LBT operation. Based on the configured/indicated time/frequency resources, the WTRU may assess the channel and report the channel assessment to the gNB. The one or more of time/frequency resources may be determined based on one or more of following:
      Explicit indication
         For example, the WTRU may be configured with one or more sets of time/frequency resources. A set of the one or more sets of time/frequency resources may be indicated to the WTRU for receiver aided LBT operation
      Implicit indication
         The WTRU may be configured with a set of time/frequency resources for each transmission type. For example, based on a configured/indicated transmission type, the WTRU may determine an associated set of time/frequency resources for each transmission type. The association between time/frequency resources and transmission types may be based on one or more of following:
         set of time/frequency resources can be configured in a channel/signal configuration. For example, a first set of time/frequency resources can be configured in a first channel/signal configuration and a second set of time/frequency resources can be configured in a second channel/signal configuration. If the WTRU receives an indication of the first channel/signal for receiver aided LBT, the WTRU may use the first set of time/frequency resources. If the WTRU receives an indication of the second channel/signal for receiver aided LBT, the WTRU may use the second set of time/frequency resources
         A set of time/frequency resources can be configured as dedicated time/frequency resources for a specific channel/signal configuration. If the specific channel/signal is used for receiver aided LBT, the set of time/frequency resources can be used
LBT category
   For example, the WTRU may be configured/indicated with one or more of LBT categories for receiver aided LBT operation. Based on the configured/indicated LBT categories, the WTRU may assess the channel and report the channel assessment to the gNB
Channel access priority class
   For example, the WTRU may be configured/indicated with one or more of channel access priority classes for receiver aided LBT operation. Based on the configured/indicated channel access priority classes, the WTRU may assess the channel and report the channel assessment to the gNB

Based on the gNB request, the WTRU may report the channel assessment result to the gNB. The WTRU report may be based on one or more of following:
Channel assessment result
   In one embodiment, the WTRU may report the channel assessment result. For example, the WTRU may report that the channel is occupied or not
   The WTRU may report one or more channel assessment results for multiple assumptions for channel assessment. For example, the WTRU may report a first channel assessment result for a first assumption and a second channel assessment result for a second assumption. The assumption may be based on one or more of following:
      Transmission type;
      Link type;
      Time and/or frequency resources for receiver-aided LBT;
      LBT category; and/or
      Channel access priority class.
Preferred parameters
   In one embodiment, the WTRU may report one or more preferred parameters based on the UE's channel assessment results. For example, the WTRU may be configured/indicated with multiple parameters for LBT. Based on the one or more parameters, the WTRU may select one or more parameters of the multiple parameters for transmission based on the UE's channel assessment results. The parameters may be based on one or more of following:
      Transmission type;
      Link type;
      Time and/or frequency resources for receiver aided LBT
      LBT category
      Channel access priority class

The WTRU may implicitly and/or explicitly report the channel assessment results. For example, the WTRU may explicitly report the channel assessment results and may indicate (e.g., via the report) whether one or more channels are clear or not. The explicit report may be transmitted using any of: PUCCH (or PSCCH), PUSCH (or PSSCH), and/or Physical Random Access Channel (PRACH).

In another example, the WTRU may implicitly report based on one or more of following:
CSI report
   For example, if the channel is clear, then the WTRU may report calculated values of CSI parameters such as one or more of CRIs, RIs, PMIs, PRIs and CQIs. If the channel is not clear, the WTRU may report specific values of CSI parameters. For example, the WTRU may report one or more of CRI=0, RI=0, PMI=0, PRI=0, and/or CQI=0.
      Based on the CSI report, the WTRU may receive a confirmation indication from the gNB (possibly using configured DL resources for the confirmation). The confirmation may be based on one or more of PDCCH, PDSCH and DL RS transmission.
RS transmission
   For example, if the channel is clear, then the WTRU may transmit RS in configured/activated RS resources (possibly configured for channel assessment report). If the channel is not clear, then the WTRU may not transmit RS.
   For example, if the channel is clear, then the WTRU may transmit RS with a first scrambling sequence. If the channel is not clear, then the WTRU may transmit RS with a second scrambling sequence.
PRACH transmission
   For example, if the channel is clear, the WTRU may transmit PRACH in configured/activated PRACH resources (possibly configured for channel assessment report). If the channel is not clear, then the WTRU may not transmit PRACH.
   For example, if the channel is clear, then the WTRU may transmit PRACH in a first PRACH resource. If the channel is not clear, then the WTRU may transmit PRACH in a second PRACH resource.

In one embodiment, a method of candidate RS resource determination for a shared spectrum operation may include: a WTRU receives multiple reference RS resources and multiple candidate RS resources; each candidate RS resource of the multiple candidate RS resources is associated with a specific number of antenna ports (e.g., 1, 2, 4, or 8 ports) and/or a transmission type (e.g., periodic, semi-persistent or aperiodic). While the multiple reference RS resources are configured in an unlicensed band, the multiple candidate RS resources are configured in a licensed band. The WTRU receives a threshold (e.g., CQI, RSRP, RSRQ, or SINR) for RS presence determination. The WTRU measures the multiple reference RS resources and determines RS presence in the multiple reference RS resources based on the threshold. If measured qualities of one or more reference RS resources are smaller than (or equal to) the threshold, the WTRU determines that RS transmission of the one or more RS resources are failed (e.g., not being present).

The WTRU determines associated candidate RS resources of the multiple candidate RS resources with the one or more reference RS resources based on number of antenna ports and/or a transmission type of the one or more reference RS resources. If a failed RS resource is configured with a first number of antenna ports and/or a first transmission type, the WTRU determines an associated candidate RS resource with the first number of antenna ports and/or the first transmission type. If number of the one or more reference RS resources is larger than number of associated candidate RS resources, the WTRU determines a set of RSs of the one or more reference RS resources based on a resource ID and/or a resource set ID of the one or more reference RS resources.

The WTRU measures RS transmission based on the determined candidate RS resources. The WTRU uses beams of the set of RSs for the measurement of the determined candidate RS resources. Actual time offset of the determined candidate RS resources is determined based on a time offset of the set of RSs and a relative time offset of the determined candidate RS resources. For example, the actual time offset=time offset #1 (configured for the set of RSs)+time offset #2 (relative time offset configured for the candidate RSs).

In one embodiment, a method of RS pre-emption indication by a gNB may include: a WTRU receives multiple RS resources with multiple RS resource IDs via RRC. The WTRU receives an indication (e.g., via MAC CE or group-common DCI) with one or more time intervals or one or more of RS resource IDs of the multiple RS resource IDs. The WTRU determines one or more RS resources of the multiple RS resources for RS pre-emption based on the one or more time intervals or the one or more RS resource IDs. If the one or more RS resources are used for radio link monitoring, the WTRU restart/stop a timer and/or a counter for radio link monitoring. The WTRU may exclude the one or more RS resources.

In one embodiment, a method of rate matching of RS candidates for other WTRUs may include: a WTRU receives multiple RS resources in a first slot and multiple REs for RE muting in a second slot via RRC. The WTRU receives one or more CORESET configurations or a threshold for RS presence determination. The WTRU determines RS presence of the first slot based on one or more of following: if the WTRU does not detect PDCCH transmission in the one or more CORESET configurations, the WTRU determines the RS is failed; if the WTRU measures RS quality smaller than (equal to) the threshold, the WTRU determines the RS is failed. The WTRU receives a PDSCH in the second slot assuming that multiple REs are muted or punctured.

In another embodiment, a method of receiver-aided LBT with LBT type indication may include: a WTRU receives multiple sets of LBT configurations based on one or more of transmission type (e.g., control, shared or RS transmission), link type (DL, UL, or SL), time/frequency resources, LBT category or LBT priority. The WTRU receives a request of receiver aided LBT indicating one or more sets of LBT configuration of the multiple sets. The WTRU reports one or more channel assessment results, wherein each channel assessment result is associated with a set of LBT configuration.

### QCL Assumption Determination for Multiple PDSCHs

In various embodiments, QCL assumption can be interchangeably used with beam, receiver beam for PDSCH(s), QCL assumption for PDSCH(s), and TCI state(s). Additionally, timeDurationForQCL may refer to time takes to process a control channel (e.g., PDCCH) received by a WTRU and to configure the receiver according to the indicated beam(s).

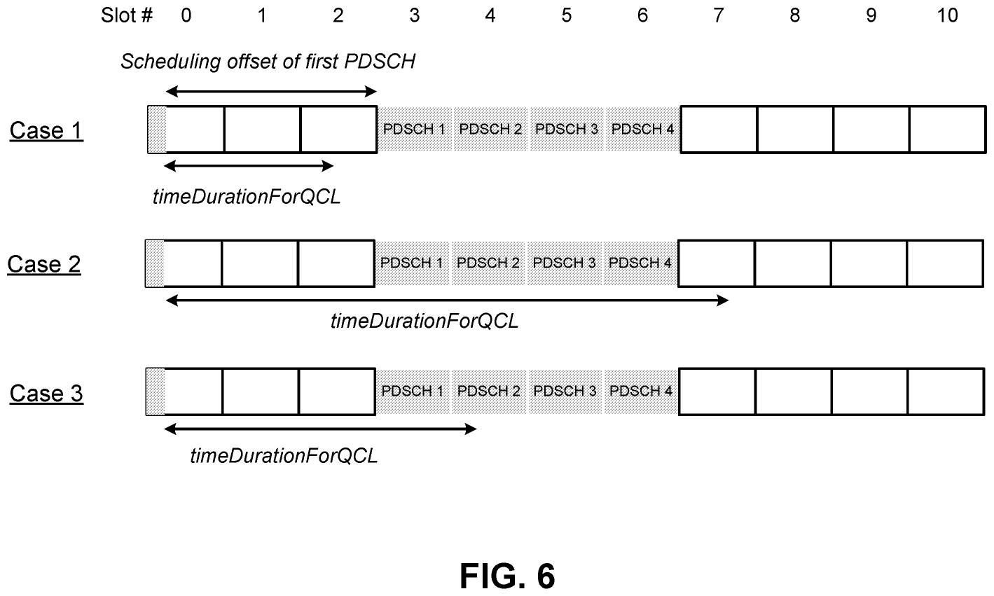

For a WTRU to determine beam for reception of each PDSCH (e.g., QCL assumption to be applied for each PDSCH reception) when multiple PDSCHs are scheduled by a single DCI (e.g., received in a PDCCH), one or a combination of the embodiments described herein may be used. Referring to FIG. 6, application of each embodiment is described with reference to three different cases that are identified based on the time it takes to process the control channel received and to configure the receiver according to the indicated beam (e.g., timeDurationForQCL) and corresponding PDSCH scheduling offsets. For example, each of the three cases (illustrated in FIG. 6) is determined based on a comparison of a PDSCH scheduling offset of the first PDSCH and a timeDurationForQCL:
Case 1: Scheduling offset of all PDSCHs≥timeDurationForQCL.
Case 2: Scheduling offset of all PDSCHs<timeDurationForQCL.
Case 3: Scheduling offset of a subset of all the scheduled PDSCHs<timeDurationForQCL.

When a Control Channel Indicates the Receiver Beam(s) to be Used

The following procedure may be followed for each case when a WTRU is indicated the receiver beam(s) to be used. For example, in Rel-16 procedures, when a WTRU is configured with the higher layer parameter tci-PresentInDCI that is set to ‘enable’ for the CORESET scheduling the PDSCH, the WTRU may assume that the TCI field is present in the DCI format 1_1 of the PDCCH transmitted on the CORESET.
Case 3: Scheduling offset of a subset of PDSCHs<timeDurationForQCL for single-Transmission/Reception Point (TRP) communication.
In an embodiment, a WTRU may follow the below alternatives to update the QCL assumption for PDSCHs in between the reception of the first and last scheduled PDSCH. Until a QCL assumption update takes place, the WTRU may apply the default QCL assumption determined for the first PDSCH based on Rel-15/16 or similar procedures.
   In an embodiment, a QCL assumption update process may be triggered by the end of timeDurationForQCL. The WTRU may choose to continue to receive all the scheduled PDSCHs without updating the QCL assumption or to change the QCL assumption to the DCI indicated beam based on one or more of the following configurations:
      The number of scheduled PDSCHs yet to be received. For example, if the number of PDSCHs yet to be received is higher than a preconfigured or MCA-CE/DCI indicated value, the WTRU may change the QCL assumption to the DCI indicted beam. Otherwise, the WTRU may continue to use the same default beam applied for the previous PDSCH reception.
      The total number of PDSCHs scheduled.
      The time gap between the first scheduled PDSCH and the last scheduled PDSCH.
      The number of PDSCH(s) or the time duration since the last update of the QCL assumption.
      The number of beam-switches the WTRU is capable of executing within a given time duration (for example, within a slot).
      SCS.
      Availability of a sufficient time gap between scheduled transmissions/receptions.
         In an embodiment, the WTRU may determine the availability of a sufficient time gap between scheduled transmissions/receptions using the time domain resource allocation (TDRA) configuration.
         In another embodiment, the WTRU may reinterpret the TDRA configuration with symbol level gaps to accommodate beam switching. A re-interpretation process may be enabled or disabled by higher layer signaling, MAC-CE, or DCI.
   In another embodiment, a QCL assumption may be updated at pre-configured/indicated intervals. That is, a WTRU may switch to an QCL assumption indicated by DCI or to a new default QCL assumption after a pre-configured/indicated number of slots/OFDM symbols from the last QCL assumption update.
      Switching to a new QCL assumption may be subject to availability of enough time gap to perform beam switching or based on RRC signaling, MAC-CE, or DCI indication.
      When a QCL assumption change takes place before timeDurationForQCL finishes, a WTRU may choose the default QCL of the latest PDSCH determined based on Rel-15/16 procedures.
      When a QCL assumption change takes place after timeDurationForQCL finishes, a WTRU may switch to the TCI state indicated in the DCI. In this case, the new QCL assumption may be used by the WTRU to receive all the remaining PDSCHs.
   In another embodiment, a WTRU may switch to the indicated beam by the gNB or to a new default beam based on the experienced quality of the received signal. For example, the WTRU may measure one or more transmitted RSs and make the beam switching decision based on L1-RSRP and/or L1-SINR. The WTRU may also decide to switch the QCL assumption based on the BLER of one or more already received PDSCHs out of the scheduled PDSCHs.
      If a beam switch takes place after timeDurationForQCL, the WTRU may switch to the QCL assumption indicted by the DCI. In this case, the new QCL assumption may be used by the WTRU to receive all the remaining PDSCHs.
      If experienced SINR/channel quality drops below a threshold value before timeDurationForQCL, the WTRU may switch the QCL assumption based on the default QCL assumption of the latest PDSCH.
Case 3: Scheduling offset of a subset of PDSCHs<timeDurationForQCL for multi-TRP communication.
In an embodiment, a WTRU may follow one or a combination of the following alternatives to update the QCL assumptions for PDSCHs in between the reception of the first and last scheduled PDSCH. Until the change in QCL assumptions takes place, a WTRU may apply the default QCL assumptions determined for the first PDSCH based on Rel-15/16 or similar procedures. That is, for single-DCI based multi-TRP, the WTRU may use the TCI-states corresponding to the lowest codepoint among the TCI codepoints containing two different TCI states which are activated by MAC-CE. For multi-DCI based multi-TRP, the WTRU assumes that the DM-RS ports of PDSCH are QCL-ed with the RS(s) with respect to the QCL parameter(s) used for PDCCH of the lowest CORESET index among CORESETs configured with the same value of CORESETPoolIndex.
   In an embodiment, a QCL assumptions update process may be triggered by the end of timeDurationForQCL. The WTRU may choose to continue to receive all the scheduled PDSCHs without updating the QCL assumptions or to change the QCL assumptions to the beams indicated by DCI based on one or more of the following configurations:
      The number of scheduled PDSCHs yet to be received.
      The total number of PDSCHs scheduled.
      The time gap between the first scheduled PDSCH and the last scheduled PDSCH.
      The number of PDSCH(s) or time duration since the last update of QCL assumption.
      The number of beam-switches the WTRU can execute within a given time duration (for example, within a slot).
      Sub-carrier spacing (SCS).
      Availability of sufficient time gap between scheduled transmissions/receptions.
         In an embodiment, the WTRU may determine the availability of a sufficient time gap between scheduled transmissions/receptions using the TDRA configuration.
         In another embodiment, the WTRU may reinterpret the TDRA configuration with symbol level gaps to accommodate beam switching. The re-interpretation process could be enabled or disabled by higher layer signaling, MAC-CE, or DCI.
   In another embodiment, a QCL assumption for each TRP may be updated at pre-configured/indicated intervals. That is a WTRU may switch to an indicated QCL assumption for each TRP or to a new default QCL assumption after a pre-configured or indicated number of slots/OFDM symbols from the last QCL assumption update. The WTRU switches to an indicated beam or to a new default beam after a pre-configured/indicated number of slots/OFDM symbols from the last QCL assumption update.
      Switching to a new QCL assumption may be subject to availability of enough time gap to perform beam switching or based on RRC signaling, MAC-CE, or DCI indication.
      When a QCL assumption change takes place before timeDurationForQCL finishes, a WTRU may choose the default QCL for each TRP based on the following procedure:
         For multi-DCI based multi-TRP, consider that the WTRU may follow the Rel-16 default QCL determination procedure for each TRP separately based on the latest PDSCH.
         For single-DCI based multi-TRP, TCI states corresponding to the next lowest codepoint containing two TCI states which are activated by MAC-CE (nth lowest codepoint containing two TCI states if this is the nth attempt to change default QCL assumptions).
      When a QCL assumption change takes place after timeDurationForQCL finishes, switch to the QCL assumptions indicated for each TRP by the TCI state indicated by the DCI. In this case, WTRU may continue to use the new QCL assumptions for the reception of all the remaining PDSCHs scheduled by the DCI.
   In another embodiment, a WTRU may switch to the beams indicated by the gNB or to new default beams for each TRP based on the experienced quality of the received signals from each TRP. For example, the WTRU may measure one or more transmitted RSs from each TRP and make the beam switching decision based on L1-RSRP and/or L1-SINR. The WTRU may also decide to switch the QCL assumption based on the BLER of one or more already received PDSCHs out of the scheduled PDSCHs.
      If beam switching takes place after timeDurationForQCL, the WTRU may switch to the QCL assumptions indicted by the DCI. In this case, the new QCL assumptions may be used by the WTRU to receive all the remaining scheduled PDSCHs.
      If beam switching takes place after timeDurationForQCL, the WTRU may update QCL assumptions for each TRP based on the following procedure:
         For multi-DCI based multi-TRP, consider that the WTRU may follow the Rel-16 default QCL determination procedure for each TRP separately based on the latest PDSCH.
         For single-DCI based multi-TRP, TCI states corresponding to the next lowest codepoint containing two TCI states which are activated by MAC-CE may be applied (nth lowest codepoint containing two TCI states if this is the nth attempt to change default QCL assumptions).

When a Control Channel does not Indicate the Receiver Beam(s) to be Used

The following procedure may be followed to determine QCL assumption(s) for all cases when a WTRU is not indicated the receiver beam(s) to be used. For example, in Rel-16 procedures, when tci-PresentInDCI field is absent, the WTRU may assume that the TCI field is not present in the DCI format 1_1 of the PDCCH transmitted on the CORESET.
Single-TRP transmission
   In an embodiment, a WTRU may apply the default QCL assumption based on the monitored CORESET with the lowest ID in the first slot a PDSCH is scheduled for all the PDSCHs.
   In another embodiment, a WTRU may determine the QCL assumption based on the monitored CORESET with the lowest ID in the slot carrying the latest received PDSCH at regular intervals, for example, after a certain number of OFDM symbols/slots from the last QCL update. Once the QCL assumption is updated, the WTRU may apply this new QCL assumption for one or multiple PDSCHs received before the next QCL assumption update is performed. Whether to determine a new QCL assumption and apply the new QCL assumption for PDSCH reception may be based on one or a combination of the following conditions:
      Total number of PDSCHs scheduled. For example, if the total number of PDSCHs scheduled is larger than an indicated/configured number, the WTRU attempts to update QCL assumption at regular intervals. Otherwise, the WTRU may continue to use the same QCL assumption.
      The duration between the first scheduled PDSCH and the last scheduled PDSCH. For example, if the gap between the first and the last PDSCH is below a certain duration, the WTRU may continue to use the same QCL assumption. Otherwise, the WTRU may update the QCL assumption at certain intervals.
      WTRU capability in beam switching.
      SCS.
      Availability of sufficient time gap between scheduled transmissions/receptions.
         In an embodiment, the WTRU may determine the availability of a sufficient time gap between scheduled transmissions/receptions using the TDRA configuration.
         In another embodiment, the WTRU may reinterpret the TDRA configuration with symbol level gaps to accommodate beam switching. The re-interpretation process could be enabled or disabled by higher layer signaling, MAC-CE, or DCI.
For multi-TRP transmission
   In an embodiment, a WTRU may apply the default QCL assumption for all the TRPs based on the monitored CORESET with the lowest ID in the first slot a PDSCH is scheduled for all the PDSCHs.
   In another embodiment, a new default QCL assumption is determined at regular intervals (for example after configured/indicated number of OFDM symbols/slots) for each TRP. This updating procedure is repeated until all the PDSCHs are received. Whether to determine new QCL assumptions and apply the new QCL assumptions for PDSCH reception may be based on the same conditions outlined for the single-TRP case.
      For multi-DCI based multi-TRP, consider that the WTRU may follow the Rel-16 default QCL determination procedure for each TRP separately based on the latest PDSCH.
      For single-DCI based multi-TRP, TCI states corresponding to the next lowest codepoint containing two TCI states which are activated by MAC-CE may be applied (nth lowest codepoint containing two TCI states if this is the nth attempt to change default QCL assumptions).

For Cross Carrier Scheduling
For cross carrier scheduling, the WTRU may determine the default QCL assumption or the single QCL assumption based on the monitored CORESET with the lowest TCI state ID when tci-PresentInDCI is absent.
   In an embodiment, a WTRU obtains a default QCL assumption for the first scheduled PDSCH from the activated TCI state with the lowest ID applicable to the PDSCH in the active BWP of the scheduled cell.
   In another embodiment, a WTRU may delay MAC-CE activation to keep one default beam for the reception of all scheduled PDSCH if MAC-CE activation takes place during the reception of PDSCHs.
      Applicable to Case 2 and/or Case 3.

For Unified TCI Framework with Multiple PDSCHs
For unified TCI framework with multi-PDSCHs, the WTRU determines the default QCL assumption based on the monitored CORESET with the lowest TCI state ID when tci-PresentInDCI is absent.
   In an embodiment, a WTRU may maintain a default QCL assumption of a first PDSCH for all the scheduled PDSCHs.
   In another embodiment, a WTRU may delay application of DCI based TCI state indication to keep one default beam for the reception of all scheduled PDSCH if MAC-CE activation takes place during the reception of PDSCHs.
      Applicable to Case 2 and/or Case 3.

From the foregoing, a WTRU may determine a QCL assumption for multiple PDSCHs in various ways. For example, the WTRU may apply a default QCL assumption and/or a DCI indicated QCL assumption for PDSCH reception. In a particular example, the WTRU may apply a default QCL assumption for multiple PDSCHs before reaching timeDurationForQCL, and apply a DCI indicated QCL assumption for the reception of the rest of the PDSCHs. Additionally, the WTRU may update QCL assumptions at regular intervals. In a particular example, the WTRU may update the QCL assumption based on a default QCL assumption procedure when DCI does not indicate a QCL assumption for PDSCH reception. Also, the WTRU may determine a QCL assumption for cross carrier scheduling. In a particular example, the WTRU may obtain a default QCL assumption for the first scheduled PDSCH from the activated TCI state. Further, the WTRU may determine a QCL assumption with a unified TCI framework with multiple-PDSCHs. In a particular example, the WTRU may determine the default QCL assumption of the first PDSCH and use it for all the PDSCHS. Then, when MAC-CE activation takes place during the reception of PDSCHs, the WTRU may delay application of the MAC-CE to keep one default beam for the reception of all scheduled PDSCH.

Dynamic RS Resource(s) Determination and RS Transmission/Reception

In one embodiment, a WTRU (e.g., WTRU 102) may be configured to determine or select one or more RS resources (e.g., candidate RS resources) based on, for example, measured quality, a transmission type, and/or a number of antenna ports. In an example, the WTRU receives configuration information of a set of RS resources, a threshold, and one or more candidate RS resources. Each candidate RS resource is associated with a respective number of antenna ports, a respective transmission type, and/or a respective time offset (e.g., a time offset of a received/measured RS transmission).

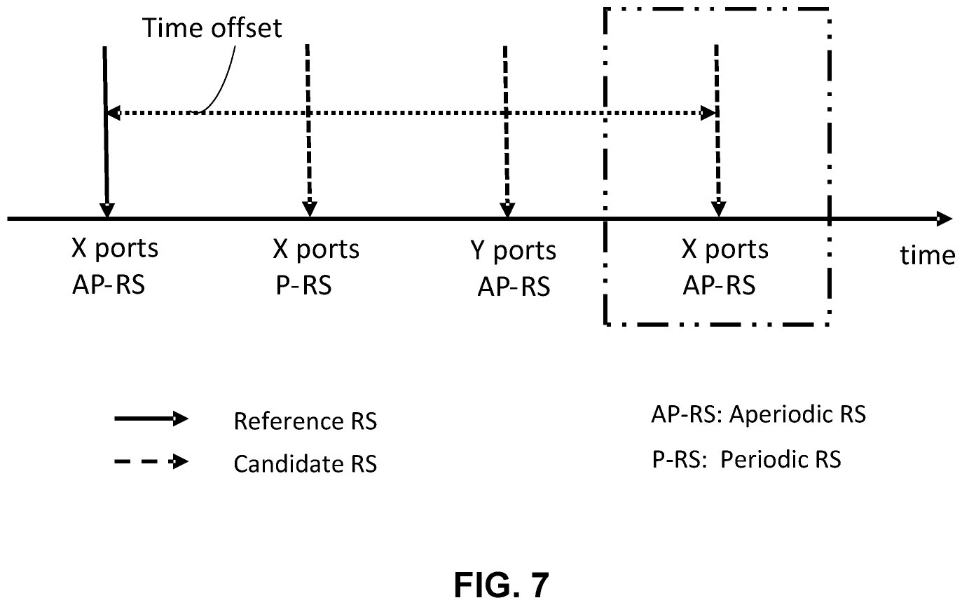

Referring to FIG. 7, an example of dynamic RS resource(s) determination based on measured quality, transmission type(s), and/or number(s) of antenna ports is provided. In this example, the WTRU receives and measures a first RS (e.g., number of antenna ports=X ports, transmission type=aperiodic RS) in an RS resource of the set of RS resources. The WTRU determines the measurement of the first RS (measured quality) and compares the measurement result (the measured quality) with a threshold (e.g., the threshold indicated in the received configuration information). If the WTRU determines that the measured RS quality is fulfilled with (or not fulfilled with, or triggered by) one or more pre-configured conditions (e.g., being less than or equal to the threshold), the WTRU may select or determine a candidate RS resource, based on the number of antenna ports and the transmission type of the first RS and of the set of candidate RSs. The WTRU may be configured to receive/measure a second RS in the selected/determined candidate RS resource.

As shown in FIG. 7, the WTRU may select (or determine to use) a candidate RS resource that has a same transmission type and a same number of antenna ports of the first received/measured RS. In this example, the candidate RS resource having the same number of antenna ports (X ports) and the same transmission type (aperiodic RS or AP-RS) is selected to be used for a late (e.g., a second, or the next) RS transmission/reception. In some cases, the candidate RS resource may be configured with (or associated with) a time offset from the time of the first RS transmission (e.g., the first RS being transmitted or received). The WTRU may be configured to receive a second RS in the selected/determined candidate RS resource using the time offset of the determined candidate RS resource. In an example, the WTRU may be configured to receive the second RS in the selected/determined candidate RS resource using beam information or QCL information (e.g., QCL type-D) of the first RS.

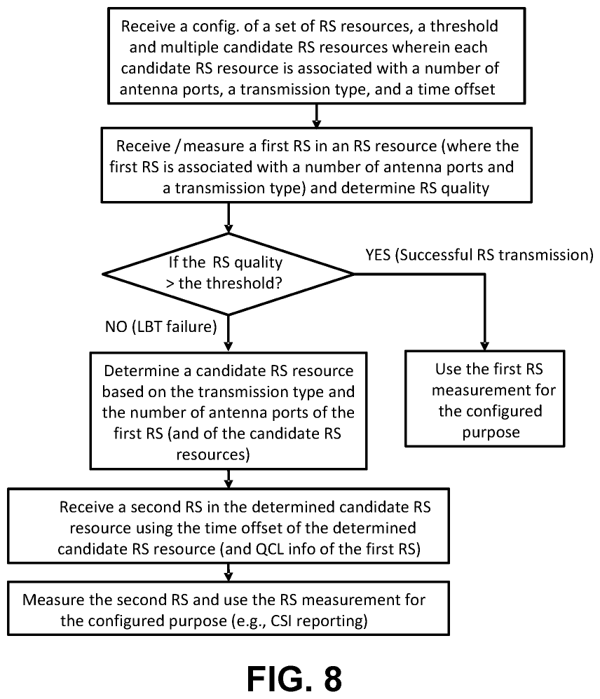

In one embodiment, referring to FIG. 8, a WTRU (e.g., WTRU 102) may be configured to determine or select one or more RS resources (e.g., candidate RS resources) based on, for example, measured quality, a transmission type, and/or a number of antenna ports. In an example as shown in FIG. 8, an operation of dynamic RS resource determination and RS transmission is provided. In this example, the WTRU may receive configuration information indicating a set of RS resources, a threshold, and one or more candidate RS resources. Each candidate RS resource may be associated with 1) a respective number of antenna ports, 2) a respective transmission type, and/or 3) a respective time offset. The configuration information may indicate one or more configured purposes. For example, the configured purpose may comprise any of: channel state information (CSI) reporting (e.g., with a RS transmission type), beam failure recovery, beam management, and/or time/frequency tracking (e.g., fine time/frequency tracking). The CSI reporting may be periodic, aperiodic, or semi-periodic CSI reporting. The RS transmission type may be periodic, aperiodic, or semi-periodic.

Still referring to FIG. 8, in this example, the WTRU may receive and measure a first RS transmission in a first RS resource (of the configured set of RS resources), and the first RS is associated with a number of antenna ports and a transmission type. In an example, if the measured quality of the first RS is less than (or equal to) the pre-configured threshold (e.g., indicated in the received configuration information), the WTRU may select (or determine) a candidate RS resource from the one or more candidate RS resources, based on i) the transmission type and ii) the number of antenna ports of the first RS (and of each of the candidate RS resources). The WTRU may receive a second RS transmission in the selected candidate RS resource using the time offset associated with the selected candidate RS resource. In some cases, the candidate RS resource may be configured with (or associated with) a time offset from the time of the first RS transmission (e.g., the first RS being transmitted or received). The WTRU may receive the second RS transmission in the selected/determined candidate RS resource using the time offset of the candidate RS resource. In an example, the WTRU may receive the second RS transmission in the selected/determined candidate RS resource using the beam information or QCL information (e.g., QCL type-D) of the first RS transmission. The WTRU may measure the second RS transmission, and use the measurement result of the second RS transmission for a configured purpose (e.g., CSI reporting). As discussed above, the received configuration information may indicate at least a configured purpose (e.g., CSI reporting, beam failure recovery, and/or fine time/frequency tracking).

In another example, if the measured quality of the first RS is above (greater than) the pre-configured threshold, the WTRU may determine that the first RS transmission is successfully received (e.g., a successful RS transmission), the WTRU may use the measurement result of the first RS transmission for the configured purpose discussed above (e.g., indicated in the received configuration information).

In one embodiment, a method implemented by the WTRU for wireless communications includes receiving configuration information indicating a set of RS resources, a set of candidate RS resources, and a threshold; receiving a first reference signal in an RS resource of the set of RS resources; selecting a candidate RS resource from the set of candidate RS resources, based on a determination that a measurement result of the received first reference signal is less than or equal to the threshold; and receiving a second reference signal in the selected candidate RS resource. Each candidate RS resource of the set of candidate RS resources may be associated with 1) a respective number of antenna ports, 2) a respective transmission type, and/or 3) a respective time offset. The first reference signal is associated with 1) a first number of antenna ports and a first transmission type.

In an example, the candidate RS resource is selected from the set of candidate RS resources further based on: 1) a first number of antenna ports and a first transmission type associated with the first reference signal, and 2) a respective number of antenna ports and a respective transmission type associated with each candidate RS resource of the set of candidate RS resources.

In another example, the candidate RS resource is selected from the set of candidate RS resources further based on: 1) a first number of antenna ports associated with the first reference signal being equal to a second number of antenna ports associated with the candidate RS resource, and 2) a first transmission type associated with the first reference signal is same as a second transmission type associated with the candidate RS resource.

In an example, the second reference signal is received in the selected candidate RS resource using the time offset associated with the selected candidate RS resource.

In an example, the method also includes determining quasi-colocation (QCL) information of the first reference signal, and the second reference signal is received in the selected candidate RS resource using the QCL information of the first reference signal.

In an example, each candidate RS resource of the set of candidate RS resources is mapped to a respective RS resource of the set of RS resources for transmission.

In an example, the method also includes determining a time offset for the second reference signal based on the candidate RS resource and/or a reference RS resource.

In an example, the configuration information indicates at least a configured purpose. The configured purpose may comprise any of: channel state information (CSI) reporting, beam failure recovery, beam management, and/or time/frequency tracking.

In an example, the method also includes measuring the second reference signal, determining the configured purpose is CSI reporting, and performing CSI reporting using the measurement of the second reference signal.

In an example, the configuration information comprises any of: a semi-static configuration of the set of candidate RS resources; a DCI and/or MAC CE based activation/deactivation; a power control offset; a scrambling ID; a periodicity; a repetition on/off indication; RSs for QCL Type A and D; and/or a different time offset.

In one embodiment, a method implemented by the WTRU for wireless communications includes receiving configuration information indicating a set of RS resources and a set of candidate RS resources; determining a LBT failure for one or more RSs associated with the set of RS resources; determining, based on the configuration information and the determined LBT failure, one or more candidate RS resources from the set of candidate RS resources; and receiving an RS transmission using the determined one or more candidate RS resources. In an example, the configuration information comprises any of: a semi-static configuration of the set of candidate RS resources; a DCI and/or MAC CE based activation/deactivation; a power control offset; a scrambling ID; a periodicity; a repetition on/off indication; RSs for QCL Type A and D; and/or a different offset.

In an example, the method may include determining a transmission time or a time offset associated with the RS transmission based on the determined LBT failure for the one or more RSs. In another example, the method may include determining a quasi-colocation (QCL) assumption for multiple Physical Downlink Shared Channels (PDSCHs) by any of: applying a default QCL assumption and a downlink control information (DCI) indicated QCL assumption for PDSCH reception; updating QCL assumptions at regular intervals; determining a QCL assumption for cross carrier scheduling; and/or determining a QCL assumption with a unified transmission configuration indicator (TCI) framework when multiple PDSCHs are scheduled by single Physical Downlink Control Channel (PDCCH) or one PDCCH per Transmission/Reception Point (TRP).

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 25 U.S.C. § 112, ¶6 or means-plus-function claim format, and any claim without the terms “means for” is not so intended.

1. A method implemented by a wireless transmit/receive unit (WTRU) for wireless communications, the method comprising:
receiving configuration information indicating a set of reference signal (RS) resources, a set of candidate RS resources, and a threshold;
receiving a first reference signal in an RS resource of the set of RS resources;
selecting a candidate RS resource from the set of candidate RS resources, based on 1) a measurement result of the received first reference signal being less than or equal to the threshold, 2) a first characteristic associated with the first reference signal, and 3) a second characteristic associated with the candidate RS resource; and
receiving a second reference signal in the selected candidate RS resource.

2. The method of claim 1, wherein each candidate RS resource of the set of candidate RS resources is associated with a respective characteristic comprising 1) a respective number of antenna ports, 2) a respective transmission type, and/or 3) a respective time offset.

3. The method of claim 1, wherein the first characteristic associated with the first reference signal comprises a first number of antenna ports and/or a first transmission type associated with the first reference signal.

4. The method of claim 1, wherein the candidate RS resource is selected from the set of candidate RS resources further based on the first characteristic associated with the first reference signal being same as the second characteristic associated with the candidate RS resource.

5. The method of claim 1, wherein the candidate RS resource is selected from the set of candidate RS resources further based on: 1) a first number of antenna ports associated with the first reference signal being equal to a second number of antenna ports associated with the candidate RS resource, and/or 2) a first transmission type associated with the first reference signal being same as a second transmission type associated with the candidate RS resource.

6. The method of claim 2, wherein the second reference signal is received in the selected candidate RS resource using the respective time offset associated with the selected candidate RS resource.

7. The method of claim 1, further comprising determining quasi-colocation (QCL) information of the first reference signal, wherein the second reference signal is received in the selected candidate RS resource using the QCL information of the first reference signal.

8. (canceled)

9. The method of claim 1, wherein each candidate RS resource of the set of candidate RS resources is mapped to a respective RS resource of the set of RS resources for transmission.

10. The method of claim 1, further comprising determining a time offset for the second reference signal based on the candidate RS resource and/or a reference RS resource.

11. The method of claim 1, wherein the configuration information indicates at least a configured purpose, wherein the configured purpose comprises any of: channel state information (CSI) reporting, beam failure recovery, beam management, and/or time/frequency tracking.

12. (canceled)

13. The method of claim 12, further comprising:
measuring the second reference signal;
determining the configured purpose is the CSI reporting; and
performing the CSI reporting using the measurement of the second reference signal.

14. The method of claim 1, wherein the configuration information comprises any of: a semi-static configuration of the set of candidate RS resources; a DCI and/or MAC CE based activation/deactivation; a power control offset; a scrambling ID; a periodicity; a repetition on/off indication; RSs for QCL Type A and D; and/or a different offset.

15-18. (canceled)

19. A wireless transmit/receive unit (WTRU) for wireless communications, comprising circuitry, including a processor, a receiver, a transmitter, and memory, configured to:
receive configuration information indicating a set of reference signal (RS) resources, a set of candidate RS resources, and a threshold;
receive a first reference signal in an RS resource of the set of RS resources;
select a candidate RS resource from the set of candidate RS resources, based on 1) a measurement result of the received first reference signal being less than or equal to the threshold, 2) a first characteristic associated with the first reference signal, and 3) a second characteristic associated with the candidate RS resource; and
receive a second reference signal in the selected candidate RS resource.

20. (canceled)

21. The method of claim 2, wherein each respective time offset is a respective time period from the time of the first reference signal being transmitted.

22. The method of claim 1, wherein the second characteristic associated with the candidate RS resource comprises a second number of antenna ports and/or a second transmission type associated with the candidate RS resource.

23. The WTRU of claim 19, wherein each candidate RS resource of the set of candidate RS resources is associated with a respective characteristic comprising 1) a respective number of antenna ports, 2) a respective transmission type, and/or 3) a respective time offset that is a respective time period from the time of the first reference signal being transmitted.

24. The WTRU of claim 19, wherein the first characteristic associated with the first reference signal comprises a first number of antenna ports and/or a first transmission type associated with the first reference signal, and wherein the second characteristic associated with the candidate RS resource comprises a second number of antenna ports and/or a second transmission type associated with the candidate RS resource.

25. The WTRU of claim 19, wherein the candidate RS resource is selected from the set of candidate RS resources further based on the first characteristic associated with the first reference signal being same as the second characteristic associated with the candidate RS resource.

26. The WTRU of claim 19, wherein the candidate RS resource is selected from the set of candidate RS resources further based on: 1) a first number of antenna ports associated with the first reference signal being equal to a second number of antenna ports associated with the candidate RS resource, and/or 2) a first transmission type associated with the first reference signal being same as a second transmission type associated with the candidate RS resource.

27. The WTRU of claim 23, wherein the second reference signal is received in the selected candidate RS resource using the respective time offset associated with the selected candidate RS resource.
